(19) United States
(12) Patent Application Publication
(10) Pub. No.: US 2023/0318040 A1
(43) Pub. Date: Oct. 5, 2023

(54) ALUMINUM-ETHER-BASED COMPOSITION FOR BATTERIES AND AMBIENT TEMPERATURE ALUMINUM DEPOSITION

(71) Applicant: Battelle Memorial Institute, Richland, WA (US)

(72) Inventors: Dan Thien Nguyen, Richland, WA (US); Vijayakumar Murugesan, Richland, WA (US); Venkateshkumar Prabhakaran, Richland, WA (US); Karl T. Mueller, Richland, WA (US)

(73) Assignee: Battelle Memorial Institute, Richland, WA (US)

(21) Appl. No.: 18/130,281

(22) Filed: Apr. 3, 2023

Related U.S. Application Data
(60) Provisional application No. 63/327,195, filed on Apr. 4, 2022.

(51) Int. Cl. H01M 10/0569; C25D 3/44; C25D 3/56; H01M 10/054; H01M 10/0568; H01M 4/134; H01M 4/38

(52) U.S. Cl. CPC H01M 10/0569; C25D 3/44; C25D 3/56; H01M 10/054; H01M 10/0568; H01M 4/134; H01M 4/38; H01M 2300/0037; H01M 2004/027

(57) ABSTRACT

Disclosed herein is an aluminum-ether-based composition that can serve a dual role as either an electrolyte for use in batteries and/or as an electroplating bath for ambient temperature aluminum deposition. The aluminum-ether-based composition facilitates aluminum ion transport between anodes and cathodes and thus can be used to replace expensive and hydroscopic ionic liquid electrolytes typically used for aluminum-based batteries. The aluminum-ether-based composition also can be used for causing aluminum deposition at ambient temperature and thus can be used to form aluminum-containing coatings with less energy consumption.

### CROSS REFERENCE TO RELATED APPLICATION

This application claims the benefit of the earlier filing date of U.S. Provisional Application No. 63/327,195 filed on Apr. 4, 2022, which is incorporated herein by reference in its entirety.

### ACKNOWLEDGMENT OF GOVERNMENT SUPPORT

This invention was made with government support under Contract DE-AC0576RL01830 awarded by the U.S. Department of Energy. The government has certain rights in the invention.

### FIELD

The present disclosure is directed to an aluminum-ether-based composition for use in batteries and aluminum deposition.

### BACKGROUND

Aluminum coating, widespread in industrial processes, has been widely adopted as a surface protection methodology for steel and alloys used for automotive and aerospace applications to provide chemical resiliency against marine and other corrosive environments encountered in the oil, gas, materials, and agricultural industries. Aluminum coating, however, is mainly conducted using hot-dip processes involving molten aluminum and/or electrodeposition from molten salts. These processes face serious problems and drawbacks concerning the environment and energy cost. And, in recent years, electrolyte solutions of AlCl₃ also have found use in rechargeable batteries; however, most electrolyte-driven deposition is based on AlCl₃-LiAH₄-diethyl ether baths (the NBS baths) and the ionic liquid-based baths. These solutions suffer from high hygroscopicity and high cost of raw materials. There exists a need in the art for a new composition suitable for aluminum deposition and/or that can serve as an electrolyte for use in aluminum-based electrode systems.

### SUMMARY

Disclosed herein are aspects of an aluminum-ether-based composition for use in electroplating an aluminum metal coating or for use in an aluminum battery, comprising: an aluminum salt component having a structure according to a formula AlX₃, wherein each X independently is a halogen atom; and an ether-based solvent having a structure according to a formula R¹—O—R², wherein each of R¹ and R² independently is selected from C₃₋₂₀alkyl, C₃₋₂₀alkenyl, C₃₋₂₀alkynyl, C₃₋₂₀haloalkyl, C₃₋₂₀haloalkenyl, or C₃₋₂₀haloalkynyl; wherein the aluminum salt component and the ether-based solvent are present in amounts that provide a molar ratio of 0.01 to 1.5 (aluminum salt component:ether-based solvent) and the aluminum-ether-based composition does not comprise, or is free of, a metal hydride and/or an ionic liquid.

In any or all of the above aspects of the disclosure, the aluminum-ether-based composition further comprises a rare earth element component having a formula REE(Z)ₙ, wherein: REE is selected from lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), scandium (Sc), yttrium (Y), or combinations thereof; each Z independently is selected from a halogen; a polyatomic anion; an alkoxy group having a formula R³O—, wherein R³ is selected from an aliphatic group, an aromatic group, a haloaliphatic group, or a combination thereof; or a combination thereof; and n is an integer selected from 3 or 4.

Also disclosed herein are aspects of a method, comprising applying a voltage to a system comprising an aluminum-containing substrate, a second substrate, and the aluminum-ether-based composition according to any or all of the above aspects of the disclosure, wherein the aluminum-containing substrate and the second substrate are positioned at a distance from one another, and the aluminum-ether-based composition comes into fluid contact with both the aluminum-containing substrate and the second substrate.

The foregoing and other objects, features, and advantages of the present disclosure will become more apparent from the following detailed description, which proceeds with reference to the accompanying figures.

### BRIEF DESCRIPTION OF THE DRAWINGS

FIGS. 1A-1F are graphs showing results from analyzing various physical properties of exemplary aluminum-ether-based compositions described herein, along with graphs pertaining to a proposed ionic conductivity mechanism for such compositions, wherein FIG. 1A shows density values as a function of temperature for a dipropyl ether-containing (“DPE”) composition at two different ratios (1 and 0.5, AlCl₃:DPE); FIG. 1B shows viscosity as a function of temperature for the AlCl₃.DPE composition; FIG. 1C shows ionic conductivity as a function of temperature for an AlCl₃.DPE composition at four different ratios (1, 0.83, 0.71, and 0.5, AlCl₃:DPE); FIGS. 1D and 1E show linewidth measurements as a function of temperature for an AlCl₃.DPE composition at a ratio of 1:2 AlCl₃:DPE (FIG. 1D) and 1:4 AlCl₃:DPE (FIG. 1E); and FIG. 1F shows spin-lattice relaxation time (Ti) of aluminum species in electrolyte solution change with temperature for three AlCl₃.DPE compositions at different ratios (1:1, 1:2, and 1:4, AlCl₃:DPE).

FIGS. 2A-2F are images obtained using molecular dynamics (“MD”) simulations for an exemplary AlCl₃.DPE composition.

FIGS. 3A-3E are ¹H nuclear magnetic resonance (NMR) spectra (FIGS. 3A-3C) and ²⁷AI NMR spectra (FIGS. 3D and 3E) obtained from analyzing an exemplary AlCl₃.DPE composition.

FIGS. 4A-4E are ¹H nuclear magnetic resonance (NMR) spectra (FIGS. 4A-4C) and ²⁷AI NMR spectra (FIGS. 4D and 4E) obtained from analyzing an exemplary AlCl₃.DBE composition.

FIGS. 5A and 5B are graphs showing diffusion coefficients as a function of AlCl₃ concentration (M) for a DPE solvent and AlCl₄₋ salt (FIG. 5A) and a DBE solvent and AlCl₄₋ salt (FIG. 5B).

FIGS. 6A and 6B are IR spectra obtained from analyzing an exemplary AlCl₃.DPE composition with AlCl₃.DPE molar ratios ranging from 1 to 0.5 (AlCl₃:DPE).

FIGS. 7A and 7B are cyclic voltammograms showing cyclic voltammetry analysis results for an exemplary AlCl₃.DPE composition at a molar ratio of 0.83 (AlCl₃:DPE) with increasing cycle numbers.

FIGS. 8A and 8B are cyclic voltammograms showing cyclic voltammetry analysis results for an exemplary AlCl₃.DBE composition at a molar ratio of 0.83 (AlCl₃:DBE) with increasing cycle numbers.

FIGS. 9A-9D are additional cyclic voltammograms showing cyclic voltammetry analysis results for an exemplary AlCl₃.DPE composition at a molar ratios of 1 AlCl₃:DPE (FIG. 9A), 0.83 AlCl₃:DPE (FIG. 9B), 0.71 AlCl₃:DPE (FIG. 9C), and 0.5 AlCl₃:DPE (FIG. 9D), with increasing cycle numbers.

FIGS. 10A and 10B show results obtained from performing linear sweep voltammetry (FIG. 10A) and chronoamperometry (FIG. 10B) of an AlCl₃.DPE composition at a ratio of 0.5 AlCl₃:DPE using a Pt electrode.

FIGS. 11A-11D show results obtained from analyzing a film deposited using an AlCl₃.DPE composition at a molar ratio of 0.5 AlCl₃:DPE, along with compositional elemental analysis of three different ratios (0.83, referred to as “AIDPE1012”; 0.71, referred to as “AIDPE1014”; and 0.5 AlCl₃:DPE, referred to as “AIDPE10120”) (FIG. 11C), wherein FIG. 11A shows an SEM image of the film; FIG. 11B shows an elemental mapping image of the film; FIG. 11C shows a graph of elemental analysis providing the average composition (wt %) of the film; and FIG. 11D shows the XRD pattern of Al deposition from the AlCl₃.DPE composition at the 0.5 molar ratio (AlCl₃:DPE).

FIGS. 12A-12F are SEM images of a deposited film obtained from using an AlCl₃.DPE composition at different molar ratios, wherein FIG. 12A shows results for the composition at a molar ratio of 0.83 (AlCl₃:DPE) using 2 mAh cm⁻² for 20 hours; FIG. 12B shows results for the composition at a molar ratio of 0.83 (AlCl₃:DPE) using 0.1 mAh cm⁻² for 20 hours; FIG. 12C shows results for the composition at a molar ratio of 0.71 (AlCl₃:DPE) using 2 mAh cm⁻² for 20 hours; FIG. 12D shows results for the composition at a molar ratio of 0.71 (AlCl₃:DPE) using 0.1 mAh cm⁻² for 20 hours; FIG. 12E shows results for the composition at a molar ratio of 0.5 (AlCl₃:DPE) using 2 mAh cm⁻² for 20 hours; and FIG. 12F shows results for the composition at a molar ratio of 0.5 (AlCl₃:DPE) using 0.1 mAh cm⁻² for 20 hours.

FIG. 13 is an SEM image of showing Al deposition film on a Cu substrate using a AlCl₃:DPE composition with molar ratio of 0.5, wherein the image was obtained from using a focused ion beam-scanning electron microscope.

FIGS. 14A-14D are spectra obtained using X-ray photoelectron spectroscopy (XPS) to analyze aluminum deposition using an exemplary AlCl₃.DPE composition having a molar ratio of 0.5 (AlCl₃:DPE), wherein FIG. 14A shows the Al 2p spectrum, FIG. 14B shows the Cl 2p spectrum, FIG. 14C shows the C 1s spectrum, and FIG. 14D shows the O 1s spectrum.

FIG. 15 is a cyclic voltammogram showing results from using a V₂O₅-ACC cathode in an AlCl₃.DPE composition having a molar ratio of 0.5 (AlCl₃:DPE).

FIG. 16 is a cyclic voltammogram showing results from using an aluminum anode and a NiCl₂ cathode with an AlCl₃.DPE composition having a molar ratio of 1 (AlCl₃:DPE).

FIG. 17 is a plot of molality and molarity as a function of DPE/AlCl₃ molar ratio for a AlCl₃:DPE composition.

FIGS. 18A and 18B are graphs showing results obtained from analyzing a deposited Al—Ce alloy film made using a composition and method according to an aspect of the present disclosure; FIG. 18A is a cyclic voltammogram of the deposited Al—Ce alloy; and FIG. 18B shows the pulsed constant voltage deposition profile of Al—Ce at−1.5 V vs. Al/Al³⁺.

FIGS. 19A and 19B are XPS spectra obtained from analyzing a deposited Al—Ce alloy film, showing the Al 2p spectrum (FIG. 19A) and Ce 3d spectrum (FIG. 19B) of the film after 10 minutes of Ar+ sputtering.

### DETAILED DESCRIPTION

Overview of Terms

The following explanations of terms and abbreviations are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements, unless the context clearly indicates otherwise.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Other features of the disclosure are apparent from the following detailed description and the claims.

Unless otherwise indicated, all numbers expressing quantities of components, molecular weights, molarities, voltages, capacities, and so forth, as used in the specification or claims are to be understood as being modified by the term “about.” Accordingly, unless otherwise implicitly or explicitly indicated, or unless the context is properly understood by a person of ordinary skill in the art to have a more definitive construction, the numerical parameters set forth are approximations that may depend on the desired properties sought and/or limits of detection under standard test conditions/methods as known to those of ordinary skill in the art. When directly and explicitly distinguishing aspects of the disclosure from discussed prior art, the numbers recited for the particular aspect of the disclosure are not approximates unless the word “about” is recited.

Although there are alternatives for various components, parameters, operating conditions, etc. set forth herein, that does not mean that those alternatives are necessarily equivalent and/or perform equally well. Nor does it mean that the alternatives are listed in a preferred order unless stated otherwise. Unless otherwise stated, any of the groups defined below can be substituted or unsubstituted.

Directions and other relative references (e.g., inner, outer, upper, lower, etc.) may be used to facilitate discussion of the drawings and principles herein, but are not intended to be limiting. For example, certain terms may be used such as “inside,” “outside,” “top,” “down,” “interior,” “exterior,” and the like. Such terms are used, where applicable, to provide some clarity of description when dealing with relative relationships, particularly with respect to any illustrated components/aspects of the disclosure. Such terms are not, however, intended to imply absolute relationships, positions, and/or orientations. For example, with respect to an object, an “upper” part can become a “lower” part simply by turning the object over. Nevertheless, it is still the same part and the object remains the same.

In order to facilitate review of the various aspects of the disclosure, the following explanations of specific terms are provided:

Aliphatic: A hydrocarbon group having at least one carbon atom to 50 carbon atoms (C1-50), such as one to 25 carbon atoms (C1-25), or one to ten carbon atoms (C1-10), and which includes alkanes (or alkyl), alkenes (or alkenyl), alkynes (or alkynyl), including cyclic versions thereof, and further including straight- and branched-chain arrangements, and all stereo and position isomers as well. Aliphatic groups are distinct from aromatic groups.

Alkenyl: An unsaturated monovalent hydrocarbon having at least two carbon atom to 50 carbon atoms (C₂₋₅₀), such as two to 25 carbon atoms (C₂₋₂₅), or two to ten carbon atoms (C₂₋₁₀), and at least one carbon-carbon double bond, wherein the unsaturated monovalent hydrocarbon can be derived from removing one hydrogen atom from one carbon atom of a parent alkene. An alkenyl group can be branched, straight-chain, cyclic (e.g., cycloalkenyl), cis, or trans (e.g., E or Z).

Alkyl: A saturated monovalent hydrocarbon having at least one carbon atom to 50 carbon atoms (C₁₋₅₀), such as one to 25 carbon atoms (C₁₋₂₅), or one to ten carbon atoms (C₁₋₁₀), wherein the saturated monovalent hydrocarbon can be derived from removing one hydrogen atom from one carbon atom of a parent compound (e.g., alkane). An alkyl group can be branched, straight-chain, or cyclic (e.g., cycloalkyl).

Alkynyl: An unsaturated monovalent hydrocarbon having at least two carbon atom to 50 carbon atoms (C₂₋₅₀), such as two to 25 carbon atoms (C₂₋₂₅), or two to ten carbon atoms (C₂₋₁₀), and at least one carbon-carbon triple bond, wherein the unsaturated monovalent hydrocarbon can be derived from removing one hydrogen atom from one carbon atom of a parent alkyne. An alkynyl group can be branched, straight-chain, or cyclic (e.g., cycloalkynyl).

Aromatic: A cyclic, conjugated group or moiety of, unless specified otherwise, from 5 to 15 ring atoms having a single ring (e.g., phenyl) or multiple condensed rings in which at least one ring is aromatic (e.g., naphthyl, indolyl, or pyrazolopyridinyl); that is, at least one ring, and optionally multiple condensed rings, have a continuous, delocalized Π-electron system. Typically, the number of out of plane Π-electrons corresponds to the Hückel rule (4n+2). The point of attachment to the parent structure typically is through an aromatic portion of the condensed ring system. For example,

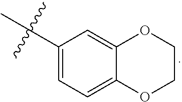 [SMILES: *c1ccc2c(c1)OCCO2]

However, in certain examples, context or express disclosure may indicate that the point of attachment is through a non-aromatic portion of the condensed ring system. For example,

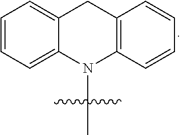 [SMILES: *N1c2ccccc2Cc2ccccc21]

An aromatic group or moiety may comprise only carbon atoms in the ring, such as in an aryl group or moiety, or it may comprise one or more ring carbon atoms and one or more ring heteroatoms comprising a lone pair of electrons (e.g. S, O, N, P, or Si), such as in a heteroaryl group or moiety. Aromatic groups may be substituted with one or more groups other than hydrogen.

Electrolyte: A substance containing free ions and/or radicals that behaves as an ionically conductive medium.

Haloaliphatic: An aliphatic group wherein one or more hydrogen atoms, such as one to 10 hydrogen atoms, independently is replaced with a halogen atom, such as fluoro, bromo, chloro, or iodo.

Heteroaliphatic: An aliphatic group comprising at least one heteroatom to 20 heteroatoms, such as one to 15 heteroatoms, or one to 5 heteroatoms, which can be selected from, but not limited to oxygen, nitrogen, sulfur, silicon, boron, selenium, phosphorous, and oxidized forms thereof within the group. Alkoxy, ether, amino, disulfide, peroxy, and thioether groups are exemplary (but non-limiting) examples of heteroaliphatic. In some aspects of the disclosure, a fluorophore can also be described herein as a heteroaliphatic group, such as when the heteroaliphatic group is a heterocyclic group.

Substrate: A physical object having a surface onto which an aluminum metal-containing coating can be electroplated, including an aluminum rare-earth alloy coating. Substrates can be solid and/or porous and can have any shape and can be made of any material suitable for having a metallic coating formed thereon. In some aspects of the disclosure, the substrate is a metal-based substrate. In yet other aspects of the disclosure, the substrate may be a non-metal substrate with surface modification with an electrical conducting substance, such as metal and/or conducting carbon layer.

### INTRODUCTION

Rechargeable aluminum (Al) battery and room temperature Al electroplating hold a huge potential for the future energy storage system and advanced surface protection methodology toward zero-emission economy. Reducing activation energy and fast kinetic for the electrochemical reduction of aluminum cation from electroactive species in organic solution is one factor lending to the success of these applications, which rely on room temperature processing and highly efficient electrodeposition of Al. Fundamental understanding regarding the AlCl₃— solvent interaction and transportation of electroactive species across the concentrations remains ambiguous, which has prevented designing electrolytes for electroplating and rechargeable batteries.

Aluminum-containing electrolytes are known in the art; however, they typically require acidic solutions that rely on using ionic liquids (e.g., tetraalkylammonium, pyridinium, imidazolium, piperidinium, pyrrolidinium cation-containing compounds), inorganic molten salts (e.g., NaCl and/or KCl), and/or organic solvent baths requiring LiAlH₄ and/or solvents like DMSO that require using high temperatures (e.g., 130° C. or higher for inorganic molten salt systems). Such compositions have drawbacks that limit their use, particularly for preparing aluminum batteries and aluminum electroplating. For example, such compositions exhibit high corrosivity towards aluminum anodes and low anodic stability. They also can result in cathode decomposition and/or dissolution. Further, they exhibit undesirable physical properties, such as being highly hygroscopic and viscous, not to mention the fact that they are expensive. Conventional methods for industrial aluminum deposition utilize hot-dip coating processes, wherein substrates (e.g., stainless steel) are immersed into molten aluminum at very high temperatures (e.g., 740° C.). Such methods are expensive and create environmental safety/efficiency concerns.

Aspects of the disclosure are directed to an aluminum-ether-based composition comprising an aluminum salt component and an ether-based solvent. The aluminum-ether-based composition is useful in electrodeposition methods and as an electrolyte for use with aluminum-based batteries and/or electrochemical cells. The ether-based solvents of the aluminum-ether-based composition exhibit desirable chelation with the aluminum salt component so as to form a fast ligand exchange complex with the aluminum salt component. Without being bound by a single theory, it currently is believed that this fast ligand exchange complex enables Al electroplating at room temperature with low overpotential. The weak coordination and fast exchange of the ether-based solvent bypass the energetically unfavorable desolvation process, thus reducing the overpotential of Al plating and eliminates the unfavorable reduction of the ether-based solvent at low overpotential. In addition, the ether-based solvent also reduces acidity of the aluminum salt component via complexation and inhibit its catalysis of H₂O dissociation, thereby reducing hygroscopicity of aluminum-ether-based composition. In other aspects of the disclosure, a method is disclosed which is directed to aluminum metal electrodeposition and/or reversible aluminum ion electrochemistry using the disclosed aluminum-ether-based composition. The method of the present disclosure can be conducted at room temperature and can provide a cost-effective, low-carbon footprint alternative to conventional aluminum deposition/electrochemical methods. Further, the chemical composition of deposited aluminum can be controlled to enhance chemical resiliency and mechanical properties.

Compositions and Coatings

Aspects of the present disclosure are directed to an aluminum-ether-based composition for use in providing an aluminum-based coating and/or for use as an electrolyte in a battery or electrochemical system. In particular aspects of the disclosure, the aluminum-ether-based composition comprises an aluminum salt component and an ether-based solvent (or a combination of multiple ether-based solvents). In some independent aspects, the aluminum-ether-based composition does not comprise, or is free of a metal hydride, an ionic liquid, or a combination thereof. In some aspects of the disclosure, the aluminum-ether-based composition consists essentially of an aluminum salt component and an ether-based solvent. In such aspects of the disclosure, the aluminum-ether-based composition is free of components that deleteriously affect the ability of the aluminum-ether-based composition to deposit aluminum, to function as an electrolyte, and/or that increases hygroscopicity of the aluminum-ether-based composition. Such components can include, but are not limited to, a metal hydride (e.g., a lithium aluminum hydride), and/or an ionic liquid (e.g., ethyl pyridinium bromide, 1-ethyl-3-methylimidazolium chloride, 1-butyl-3-methylimidazolium chloride, and the like). In some aspects of the present disclosure, the aluminum-ether-based composition can consist of an aluminum salt component, an ether-based solvent (or two or more of such components), and one or more optional functional additives added to, for example, increase ionic conductivity of the composition, to improve the morphology of Al coating deposition, and/or reduce flammability. Exemplary such optional functional additives can include metal halides, aluminum salts with polyatomic anions, quaternary ammonium halides, sulfone solvents, pyridine derivatives, organic phosphate compounds, triphenylphosphate, and tributylphosphate.

The aluminum salt component typically is a salt capable of providing Al³⁺ ions. In particular aspects of the disclosure, the aluminum salt component has a formula AlX₃, wherein each X independently is a suitable counterion. In particular aspects of the disclosure, each X independently is a halogen atom, such as Cl, Br, I, F, or combinations thereof. In representative aspects of the disclosure, each X independently is Cl, Br, or I and the aluminum salt can be selected from AlCl₃, AlF₃, AlBr₃, and/or AI(I)₃. In some aspects of the disclosure, a mixture of two or more aluminum salt components can be used in the aluminum-ether-based composition.

The ether-based solvent can be selected from compounds having a structure according to a formula R¹—O—R², wherein each of R¹ and R² independently is selected from an aliphatic group, an aromatic group, a heteroaliphatic group, a haloaliphatic group, or a combination thereof, wherein any such aliphatic, heteroaliphatic, or haloaliphatic groups can be linear, branched, or cyclic. In particular aspects of the disclosure, each of R¹ and R² independently is selected from alkyl, alkenyl, alkynyl, heteroalkyl, heteroalkenyl, heteroalkynyl, haloalkyl, haloalkenyl, haloalkynyl, aryl, heteroaryl, or any combination thereof, and wherein any of the groups other than aryl and heteroaryl can be linear, branched, or cyclic. In some aspects of the disclosure, each of R¹ and R² independently is selected from C₁₋₂₀alkyl, C₂₋₂₀alkenyl, C₂₋₂₀alkynyl, C₁₋₂₀heteroalkyl, C₂₋₂₀heteroalkenyl, C₂₋₂₀heteroalkynyl, C₁₋₂₀haloalkyl, C₂₋₂₀haloalkenyl, C₂₋₂₀haloalkynyl, C₆₋₁₅aryl, C₁₋₁₅heteroaryl, or any combination thereof, and wherein any of the groups other than C₆₋₁₅aryl and C₁₋₁₅heteroaryl groups can be linear, branched, or cyclic. In particular aspects of the disclosure of the ether-based solvent, each of R¹ and R² independently is selected from C₃₋₂₀alkyl, C₃₋₂₀alkenyl, C₃₋₂₀alkynyl, C₃₋₂₀haloalkyl, C₃₋₂₀haloalkenyl, or C₃₋₂₀haloalkynyl, wherein any such groups can be linear, branched, or cyclic. In yet other particular aspects of the disclosure, each of R¹ and R² independently is selected from C₃₋₁₀alkyl, C₃₋₁₀alkenyl, C₃₋₁₀alkynyl, C₃₋₁₀haloalkyl, C₃₋₁₀haloalkenyl, or C₃₋₁₀haloalkynyl, wherein any such groups can be linear, branched, or cyclic. In representative aspects of the disclosure, each of R¹ and R² independently is selected from propyl (including linear, branched, or cyclic versions thereof), butyl (including linear, branched, or cyclic versions thereof), pentyl (including linear, branched, or cyclic versions thereof), hexyl (including linear, branched, or cyclic versions thereof), septyl (including linear, branched, or cyclic versions thereof), octyl (including linear, branched, or cyclic versions thereof), nonyl (including linear, branched, or cyclic versions thereof), decyl (including linear, branched, or cyclic versions thereof), or any such groups wherein at least one carbon atom is replaced with a halogen, such as Cl, F, I, or Br, with particular halogenated compounds comprising F. In particular aspects, each of R¹ and R² independently is selected from n-propyl, n-butyl, or n-pentyl. Representative ether-based solvents can include, but are not limited to, dipropyl ether (or “DPE”), dibutyl ether (or “DBE”), diethyl ether (or “DEE”), or pentafluoroethyl ethyl ether, 1,1,1,2,2-pentafluoro-2-(perfluoroethoxy)ethane, trifluoro(trifluoromethoxy)methane, methoxyperfluorobutane, 1-methoxyheptafluoropropane, 4-(trifluoromethoxy)-1-fluorobenzene, 4-fluoroanisole, or combinations thereof. In some aspects of the disclosure, a mixture of ether-based solvents can be used, such as mixture of two or more ether-based solvents, such as a mixture of two or more of the above-mentioned ether-based solvents.

In yet further aspects of the disclosure, the aluminum-ether-based composition can comprise the aluminum salt component in combination with a rare earth element component. In such aspects of the disclosure, the aluminum-ether-based composition can comprise a rare earth element component having a formula according to REE(Z)ₙ, wherein REE is a rare earth element selected from lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), scandium (Sc), yttrium (Y), or combinations thereof; and n is an integer selected from 1 to 4, such as 1, 2, 3, or 4. Each Z group of formula REE(Z)n independently is selected from a halogen (e.g., Br, C1, F, I, or a combination thereof); a polyatomic anion (e.g., PF₆, ClO₄, BF₄, TFSI, FSI, carboxylates and their fluorinated derivatives thereof, or any combination thereof); an alkoxy group having a formula R³⁰⁻ (wherein the REE is bound to or coordinated with the oxygen atom); or a combination thereof. With reference the formula R³⁰⁻, R³ is selected from an aliphatic group, an aromatic group, a haloaliphatic group, or a combination thereof, wherein any such aliphatic or haloaliphatic groups can be linear, branched, or cyclic. In particular aspects of the disclosure, R³ is selected from alkyl, alkenyl, alkynyl, haloalkyl, haloalkenyl, haloalkynyl, aryl, heteroaryl, or any combination thereof, and wherein any of the groups other than aryl and heteroaryl can be linear, branched, or cyclic. In some aspects of the disclosure, R³ is selected from C₁₋₂₀alkyl, C₂₋₂₀alkenyl, C₂₋₂₀alkynyl, C₁₋₂₀haloalkyl, C₂₋₂₀haloalkenyl, C₂₋₂₀haloalkynyl, C₆₋₁₅aryl, C₁₋₁₅heteroaryl, or any combination thereof, and wherein any of the groups other than C₆₋₁₅aryl and C₁₋₁₅heteroaryl groups can be linear, branched, or cyclic. In particular aspects of the disclosure, R³ is selected from C₃₋₂₀alkyl, C₃₋₂₀alkenyl, C₃₋₂₀alkynyl, C₃₋₂₀haloalkyl, C₃₋₂₀haloalkenyl, or C₃₋₂₀haloalkynyl, wherein any such groups can be linear, branched, or cyclic. In yet other particular aspects of the disclosure, R³ is selected from C₃₋₁₀alkyl, C₃₋₁₀alkenyl, C₃₋₁₀alkynyl, C₃₋₁₀haloalkyl, C₃₋₁₀haloalkenyl, or C₃₋₁₀haloalkynyl, wherein any such groups can be linear, branched, or cyclic. In representative aspects of the disclosure, R³ is selected from propyl (including linear, branched, or cyclic versions thereof), butyl (including linear, branched, or cyclic versions thereof), pentyl (including linear, branched, or cyclic versions thereof), hexyl (including linear, branched, or cyclic versions thereof), septyl (including linear, branched, or cyclic versions thereof), octyl (including linear, branched, or cyclic versions thereof), nonyl (including linear, branched, or cyclic versions thereof), decyl (including linear, branched, or cyclic versions thereof), or any such groups wherein at least one carbon atom is replaced with a halogen, such as Cl, F, I, or Br, with particular halogenated compounds comprising F. In particular aspects of the disclosure, the rare earth component has a formula REE(Z)ₙ, wherein REE is Ce, Z is Cl, and n is 3.

In some independent aspects, any aluminum-ether-based composition comprising an aluminum salt component in combination with a rare earth element component does not comprise, or is free of a metal hydride, an ionic liquid, or a combination thereof. In some aspects of the disclosure, an aluminum-ether-based composition comprising a combination of an aluminum salt component and a rare earth element component consists essentially of the aluminum salt component, the rare earth element component, and an ether-based solvent. In such aspects of the disclosure, the aluminum-ether-based composition is free of components that deleteriously affect the ability of the aluminum-ether-based composition to deposit an aluminum-rare earth alloy or that increases hygroscopicity of the aluminum-ether-based composition. Such components can include, but are not limited to, a metal hydride (e.g., a lithium aluminum hydride) and/or an ionic liquid (e.g., ethyl pyridinium bromide, 1-ethyl-3-methylimidazolium chloride, 1-butyl-3-methylimidazolium chloride, and the like). In some aspects of the present disclosure, an aluminum-ether-based composition comprising a combination of an aluminum salt component and a rare earth element component consists of the aluminum salt component, the rare earth element component, the ether-based solvent (or two or more of such components), and one or more optional functional additives added to, for example, increase ionic conductivity of the composition, to improve the morphology of Al coating deposition, and/or reduce flammability. Exemplary such optional functional additives can include metal halides, aluminum salts with polyatomic anions, quaternary ammonium halides, sulfone solvents, pyridine derivatives, organic phosphate compounds, triphenylphosphate, and tributylphosphate.

The amount of the aluminum salt component and the ether-based solvent can be selected to provide a suitable viscosity of the aluminum-ether-based composition for use in method aspects described herein. In some aspects of the disclosure, the viscosity is not so viscous that atoms of components of the aluminum-ether-based composition are immobilized when a voltage is applied and/or when the aluminum-ether-based composition is at ambient temperature. In some aspects of the disclosure, the viscosity of the aluminum-ether-based composition is typically such that atoms are able to be mobile when a voltage is applied and/or when the aluminum-ether-based composition is at ambient temperature. In some aspects of the disclosure, the viscosity of electrolyte might vary depend on salts and additives concentration but typically can be below 10 mPa·s. In some aspects of the disclosure, the aluminum salt component can be present in an amount that provides a molar ratio of aluminum salt component:ether-based solvent (wherein the ether-based solvent component is the amount of a single ether-based solvent or a total amount if two or more such solvents are used) ranging from 0.01 to 50, such as 0.125 to 50, or 0.5 to 25, or 0.5 to 15, or 0.5 to 10, or 0.5 to 5, or 0.5 to 2, or 0.5 to 1.5 or 0.5 to 1. In particular aspects of the disclosure, the amount of aluminum salt component is an amount that provides a molar ratio of aluminum salt component:ether-based solvent that ranges from 0.01 to 1.5, such as 0.5 to 1, or 0.5 to 0.83 or 0.5 to 0.71. In particular aspects of the disclosure, the aluminum salt component is present in an amount providing a molar ratio of aluminum salt component:ether-based solvent that is 0.5, 0.71, 0.83, or 1. In yet additional aspects of the disclosure, the aluminum salt component can be present in an amount that provides a molar concentration ranging from greater than 0 M to 10 M, such as 1 M to 10 M, or 2 M to 8 M, or 2.9 M to 7.3 M, or 2.9 M to 6.1 M, or 2.9 M to 5.2 M, or 2.9 M to 4.8 M, or 3.7 M to 7.3 M, or 3.7 M to 6.1 M, or 3.7 M to 5.2 M. In particular representative aspects of the disclosure, the concentration of the aluminum salt component is 2.9 M, 3.7 M, 4.1 M, 4.8 M, 5.2 M, 5.8 M, 6.1 M, or 7.3 M. In aspects of the disclosure comprising a rare earth element component, the rare earth element component can be included at a concentration ranging from 0.001 M to 5 M, such as 0.01 M to 5M, or 0.1 M to 5 M, or 0.25 M to 5 M, or 0.5 M to 5 M, or 1 M to 5M. In representative aspects of the disclosure the rare earth element component is included at a concentration of 0.25 M.

Representative examples of the aluminum-ether-based composition of the present disclosure can comprise AlCl₃ and DPE; AlCl₃ and DBE; AlBr₃ and DPE; AlBr₃and DBE; AI(I)₃ and DPE; AI(I)₃ and DBE; AlF₃ and DPE; AlF₃ and DBE; AlCl₃, CeCl₃, and DPE; or AlCl₃, CeCl₃, and DBE. For example, some representative examples can include AlCl₃:DPE at molar ratio of 1, 0.83, 0.5, 0.25; AlCl₃:DBE at molar ratio of 1, 0.83, 0.5, 0.25; AlCl₃:DPE at molar ratio of 0.5 with addition of CeCl₃ less than 0.25 M; and AlCl₃:DBE at molar ratio of 0.5 with addition of CeCl₃ less than 0.25 M.

Without being limited to a single theory of operation, it currently is believed that the aluminum salt component and the ether-based solvent are able to form electroactive species through solvent-solute interactions and that the disclosed aluminum salt components and ether-based solvents are able to form fast ligand exchange complexes that facilitate aluminum deposition at ambient temperatures with low overpotential. It also is currently believed that the ether-based solvents exhibit a level of basicity that reduces the acidity of the aluminum salt component and thus inhibits catalysis of H₂O dissociation, thereby reducing the hygroscopicity of the aluminum-ether-based composition. In some aspects of the disclosure, the aluminum-ether-based composition is used to form an aluminum-based coating that exhibits desirable morphology and/or durability. In particular aspects of the disclosure, the coating is even along the surface of the substrate on which it is formed and does not exhibit patches of aluminum that are deposited randomly over the surface area of the substrate (or at least exhibits a low number of such patches). In some aspects of the disclosure, the coating can be slightly porous, with particular aspects of the disclosure exhibiting a porosity ranging from greater than 0 to less than 0.1%, such as 0.01% to 0.1%. In some aspects of the disclosure, the deposited coating can comprise polycrystalline aluminum, a nanofilm of aluminum, and/or amorphous aluminum.

In some aspects of the disclosure, the aluminum-based coating can be deposited on a substrate. In some aspects of the disclosure, the substrate can be an electrically conductive substrate or a non-conductive substrate with or without an applied conductive coating. In particular aspects of the disclosure, the substrate can be a metal substrate, such as a Mo substrate, a copper (Cu) substrate, a Zr substrate, a steel substrate, a uranium (U) substrate, an aluminum (Al) substrate, a gold (Au) substrate, or substrates comprising combinations of any such materials. Exemplary non-conductive substrates can include, but are not limited to, substrates comprising polyethylene terephthalate, Teflon®, cotton paper, non-woven glass, epoxy, and ceramic materials.

In some aspects of the disclosure, the integrity and/or physical features of the aluminum-based coating provided by the aluminum-ether-based composition can be measured. Such measurements can involve using X-ray fluorescence (XRS) to determine atomic composition of a coating; scanning electron microscopy (SEM) to evaluate coating thickness; optical microscopy to evaluate coating uniformity; energy dispersive spectroscopy (EDS) to evaluate the chemical make-up of the coating; X-ray photoelectron spectroscopy (XPS) to evaluate surface states and chemistry; X-ray diffraction (XRD) to evaluate the crystallinity and composition of the coating; and/or oxidation experiments to determine coating thickness, variation, and/or to confirm the presence of the coating. Some such techniques are discussed herein.

In some aspects of the disclosure, thin aluminum-based coatings can be prepared using the aluminum-ether-based composition of the present disclosure. In some aspects of the disclosure, the aluminum-ether-based composition can be used to provide a coating having any desired thickness, which can be determined depending on the desired end use. In particular aspects of the disclosure, the thickness can be modified by controlling the current and/or duration of coating application. In some aspects of the disclosure, substrates comprising a thin coating of aluminum (and/or an alloy thereof) are desirable in certain industries and can be made using an aluminum-ether-based composition of the present disclosure.

Methods

Aspects of the disclosure also are directed to a method for using the aluminum-ether-based composition of the present disclosure. The method comprises exposing a system comprising an aluminum-containing substrate and a second substrate to an aluminum-ether-based composition of the present disclosure and applying a voltage to the system. In particular aspects of the present disclosure, the method comprises applying a voltage to a system comprising an aluminum-containing substrate, a second substrate, and an aluminum-ether-based composition according to the present disclosure, wherein the aluminum-containing substrate and the second substrate are positioned at a distance from one another, and the aluminum-ether-based composition comes into fluid contact with both the aluminum-containing substrate and the second substrate.

In some aspects of the disclosure, the method is an electrodeposition method wherein the aluminum-ether-based composition is used to provide a deposited layer of aluminum metal and/or an aluminum-rare earth element alloy on a substrate. In such aspects of the disclosure, the aluminum-containing substrate is provided as a counter electrode and the second substrate comprises a metal substrate capable of acting as a working electrode upon which aluminum metal and/or an aluminum-rare earth element alloy can be deposited. The aluminum-containing substrate can comprise aluminum metal or an aluminum alloy. In aspects of the disclosure employing an aluminum alloy substrate, the aluminum alloy can comprise aluminum and a rare earth element selected from Ce, La, Gd, Nd, Dy, Pr, Tb, Y, Sc, Eu, Sm, Er, Ho, Lu, Tm, Yb, Pm, or combinations thereof. In particular aspects of the disclosure, the aluminum alloy is an aluminum-cerium alloy. The aluminum-ether-based composition serves as a source of Al³⁺ ions (or Al³⁺ and REEⁿ⁺+ ions) that can be reduced and deposited on the second substrate as aluminum metal. In such aspects of the disclosure, the voltage applied to the system is provided as a negative potential or a negative current and is applied to the second substrate.

Aspects of the method disclosed herein can be used to deposit aluminum-based coatings on substrates, such as those described herein. In some aspects of the disclosure, the aluminum-based coating can fully or partially coat the surface area of the substrate. For example, in some aspects of the disclosure, for any particular amount of surface area that is desired to be coated with the aluminum-based coating using the aluminum-ether-based composition can be coated such that more than 80% to 100% of that desired surface area can be coated with the aluminum-based coating, such as greater than 80% to 100%, or 90% to 100%, or 95% to 100%, or 98% to 100%.

In some other aspects of the disclosure, the method is an electrochemical method wherein the aluminum-ether-based composition is used as an electrolyte that facilitates Al³⁺ transport between an anode and a cathode. In such aspects of the disclosure, the aluminum-containing substrate serves as an aluminum anode and the second substrate is selected from a material capable of serving as a cathode. In some aspects of the disclosure, the cathode can be a metal-halide-based cathode (e.g., a metal-chloride- and/or metal-fluoride-based cathode), a vanadium-based cathode, an organic cathode (e.g., a carbon-based cathode and/or a sulfur-based cathode), or a metal chalcogenide-based cathode. In such aspects of the disclosure, the disclosed aluminum-ether-based composition can be used as an electrolyte in view of its ability to promote reversible aluminum plating and stripping. In some aspects of the disclosure, the voltage used in the method is a charging voltage and is applied as DC, AC, or a combination thereof. Applying the voltage to the system results in Al³⁺ ion transport between the aluminum anode and the cathode and through the aluminum-ether-based composition. In such aspects of the disclosure, applying the voltage to the system produces electrical energy. The system used in such methods can further comprise a separator and/or a membrane.

Overview of Several Aspects of the Disclosure

Disclosed herein are aspects of an aluminum-ether-based composition for use in electroplating an aluminum metal coating or for use in an aluminum battery, comprising: an aluminum salt component having a structure according to a formula AlX₃, wherein each X independently is a halogen atom; and an ether-based solvent having a structure according to a formula R¹—O—R², wherein each of R¹ and R² independently is selected from C₃₋₂₀alkyl, C₃₋₂₀alkenyl, C₃₋₂₀alkynyl, C₃₋₂₀haloalkyl, C₃₋₂₀haloalkenyl, or C₃₋₂₀haloalkynyl; wherein the aluminum salt component and the ether-based solvent are present in amounts that provide a molar ratio of 0.01 to 1.5 (aluminum salt component:ether-based solvent) and the aluminum-ether-based composition does not comprise, or is free of, a metal hydride and/or an ionic liquid.

In any or all aspects of the disclosure, the aluminum salt component is AlCl₃, AlF₃, AlBr₃, AI(I)₃, or a combination thereof.

In any or all of the above aspects of the disclosure, the aluminum salt component is AlCl₃.

In any or all of the above aspects of the disclosure, each of R¹ and R² independently is selected from C₃₋₁₀alkyl or C₃₋₁₀haloalkyl.

In any or all of the above aspects of the disclosure, each of R¹ and R² independently is selected from n-propyl, n-butyl, n-pentyl, or any fluorinated version thereof.

In any or all of the above aspects of the disclosure, the composition comprises AlCl₃ and a mixture of two or more ether-based solvents.

In any or all of the above aspects of the disclosure, the molar ratio ranges from 0.5 to 1.

In any or all of the above aspects of the disclosure, the aluminum-ether-based composition further comprises a rare earth element component having a formula REE(Z)ₙ, wherein: REE is selected from lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), scandium (Sc), yttrium (Y), or combinations thereof; each Z independently is selected from a halogen; a polyatomic anion; an alkoxy group having a formula R³⁰⁻, wherein R³ is selected from an aliphatic group, an aromatic group, a haloaliphatic group, or a combination thereof; or a combination thereof; and n is an integer selected from 3 or 4.

In any or all of the above aspects of the disclosure, the rare earth element component is CeCl₃.

Also disclosed herein are aspects of a battery, comprising: the aluminum-ether-based composition according any or all of the above aspects of the disclosure; an aluminum anode; and a cathode.

In any or all of the above aspects of the disclosure, the cathode is a metal-halid-based cathode, a vanadium-based cathode, an organic cathode, or a metal-chalcogenide-based cathode.

In any or all of the above aspects of the disclosure, the aluminum-ether-based composition comprises (i) AlCl₃ and (ii) dipropyl ether or dibutyl ether, wherein (i) and (ii) are present in amounts providing a ratio ranging from 0.5 to 1.

Also disclosed herein are aspects of a method, comprising applying a voltage to a system comprising an aluminum-containing substrate, a second substrate, and the aluminum-ether-based composition according to any or all of the above aspects of the disclosure, wherein the aluminum-containing substrate and the second substrate are positioned at a distance from one another, and the aluminum-ether-based composition comes into fluid contact with both the aluminum-containing substrate and the second substrate.

In any or all of the above aspects of the disclosure, the aluminum-containing substrate is an aluminum anode and the second substrate is a cathode.

In any or all of the above aspects of the disclosure, the voltage is a charging voltage and is applied as DC, AC, or a combination thereof.

In any or all of the above aspects of the disclosure, applying the voltage to the system results in Al³⁺ ion transport between the aluminum anode and the cathode and through the aluminum-ether-based composition.

In any or all of the above aspects of the disclosure, the method produces electrical energy.

In any or all of the above aspects of the disclosure, the system further comprises a separator and/or a membrane component positioned between the aluminum-containing substrate and the second substrate.

In any or all of the above aspects of the disclosure, the aluminum-containing substrate is an aluminum metal counter electrode and the second substrate is a working electrode and comprises a substrate upon which aluminum metal can be deposited upon exposure of the system to the voltage.

In any or all of the above aspects of the disclosure, the voltage is a negative potential versus Al/Al³⁺, or a negative current applied to the substrate upon which the aluminum metal is deposited.

In any or all of the above aspects of the disclosure, applying the voltage to the system results in electrodepositing an aluminum metal layer on the second substrate; or wherein the aluminum-ether-based composition further comprises a rare earth element component and applying the voltage to the system results in electrodepositing an aluminum-rare earth element alloy layer on the second substrate.

### EXAMPLES

### Example 1

In this example, different compositions were prepared comprising a mixture of AlCl₃ and either dipropyl ether (DPE) or dibutyl ether (DBE), using different ratios of AlCl₃: solvent and/or different AlCl₃ concentrations. The dissolution of AlCl₃ into dipropyl ether (DPE) and dibutyl ether (DBE) formed a slight yellowish solution and the color increased at higher concentration of AlCl₃. In both solvents, the AlCl₃ can be dissolved with the AlCl₃:solvent up 1:1 molar ratio and reached its saturation. Certain physical properties of electrolytes with various AlCl₃: solvents are summarized in Table 1.

TABLE 1
Concentrations and physical properties of AlCl₃•DPE
solutions with AlCl₃:DPE ratio between 1 to 0.5.

| | AlCl₃: | Molality of | Density | Viscosity |
|---|---|---|---|---|
| | solvent | AlCl₃ | (g/cm³) | (mPa · s) |
| Solvents | ratio | concentration m) | at 25° C. | at 25° C. |
| DPE | 1 | 9.788 | 1.167 | 7.153 |
| DPE | 0.83 | 8.156 | — | — |
| DPE | 0.71 | 6.991 | — | — |
| DPE | 0.50 | 4.894 | 1.0034 | 1.748 |
| DBE | 1 | 7.679 | | |
| DBE | 0.83 | 6.399 | | |
| DBE | 0.71 | 5.485 | | |
| DBE | 0.5 | 3.839 | | |

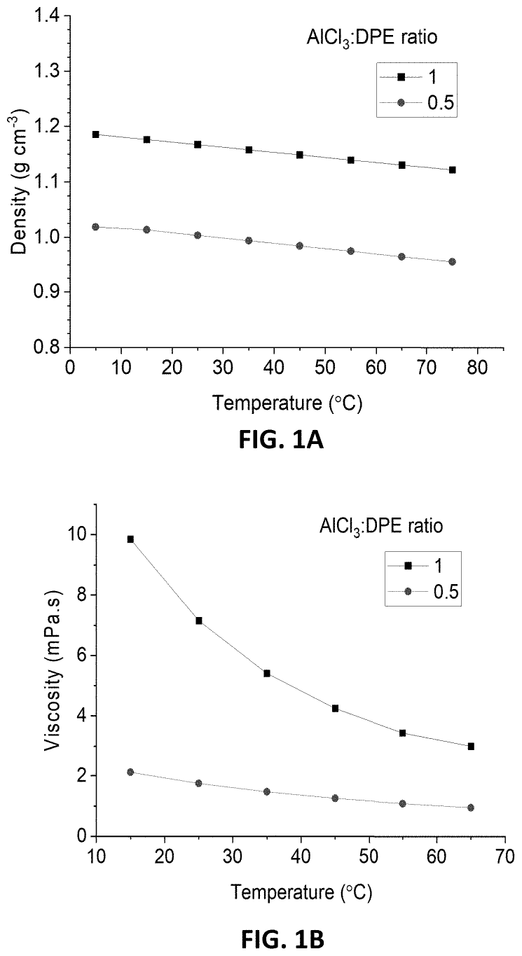

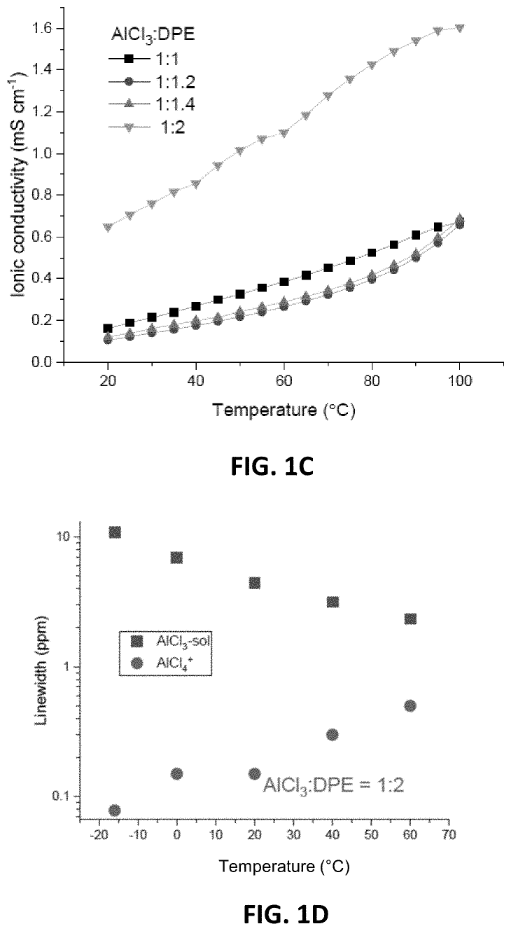

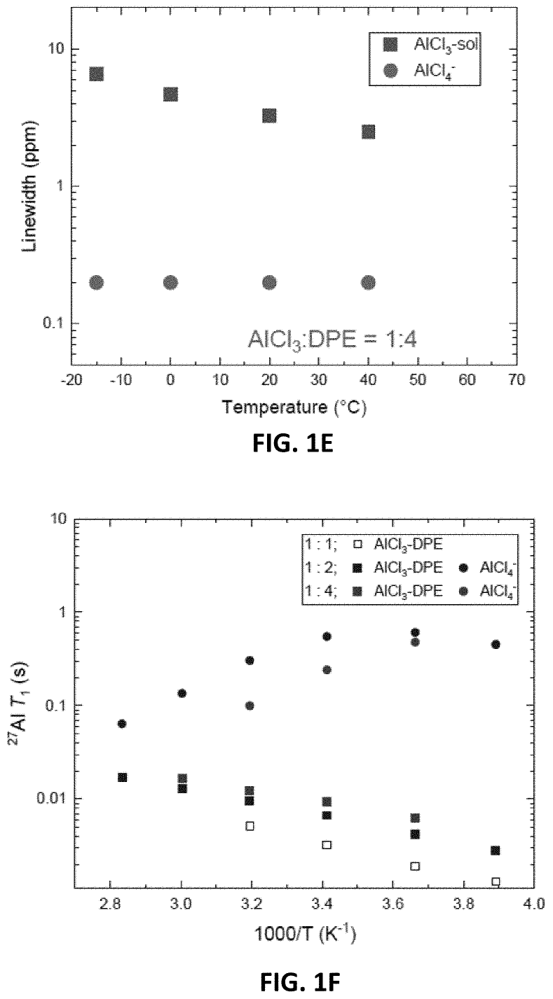

At saturation, the AlCl₃ can be dissolved at an equal molar amount with DPE and results in a composition having a high density (e.g., 1.167 g/cm³) (FIG. 1A) and viscosity (e.g., 7.153 mPa·s). At this ratio, the solution is expected to contain no free solvent molecule. The viscosity reduces rapidly with temperature (FIG. 1B). The low concentration solution has higher ionic conductivity compared to that of high concentration (see FIG. 1C), which may be explained by a lower viscosity and formation of charge species at lower concentration of AlCl₃. Additional results concerning ionic conductivity measurement are shown in FIGS. 1D-1F, which show that with increased temperature, AlCl₄ linewidth increases at higher concentrations (e.g., 1:2), which may indicate that the interaction between AlCl₄₋ and AlCl₄.DPE reduces symmetry of the AlCl₄₋ complex.

### Example 2

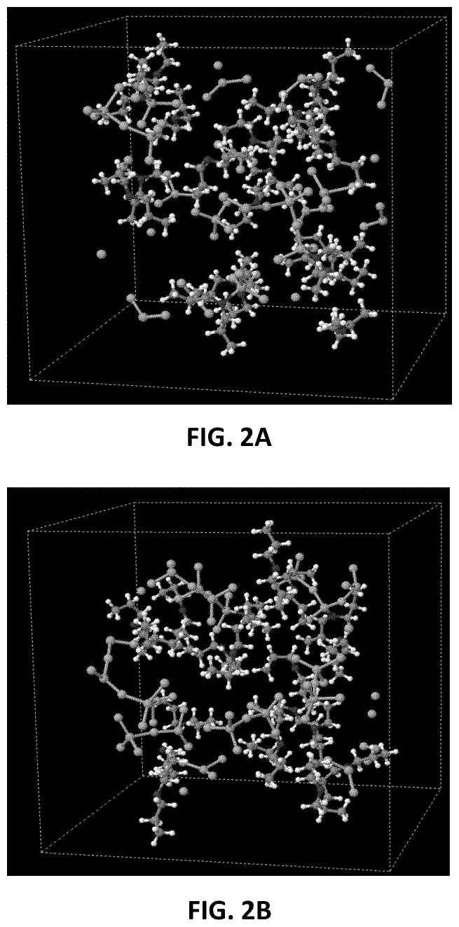

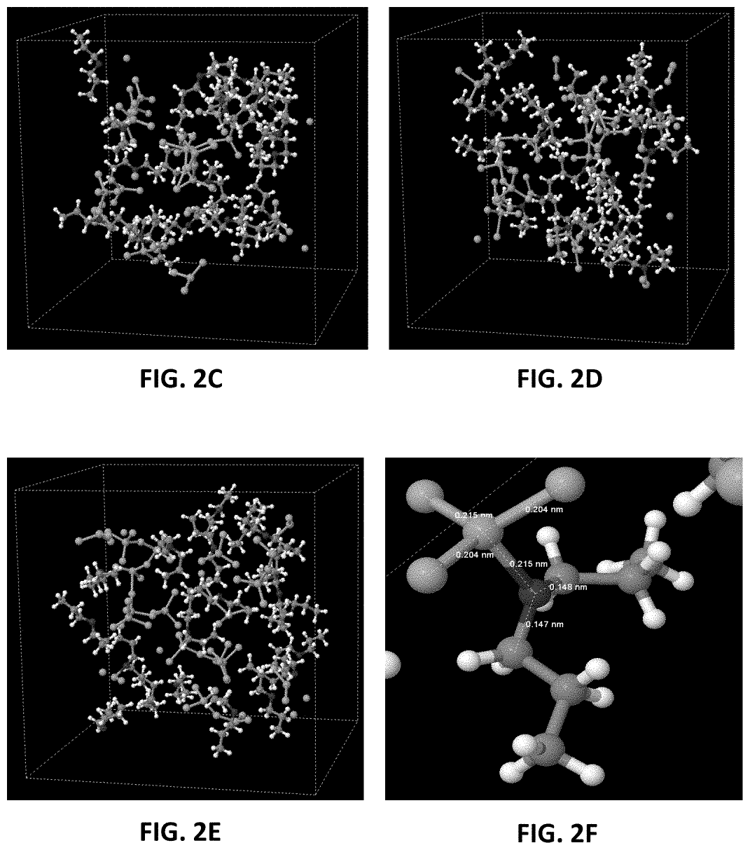

In this example, molecular dynamics (MD) simulation was used to evaluate complexes formed between AlCl₃ and DPE. The MD simulation of the AlCl₃.DPE composition (FIGS. 2A-2F, showing different view angles of the simulation) revealed the formation of tetra coordination AlCl₃.DPE. In addition, the simulation models also suggest the present of charge species such as [AlCl₂.DPE₂]⁺, [AlCl₄]⁻, and a polymer chain such as [Al₅Cl₁₆]⁺.

### Example 3

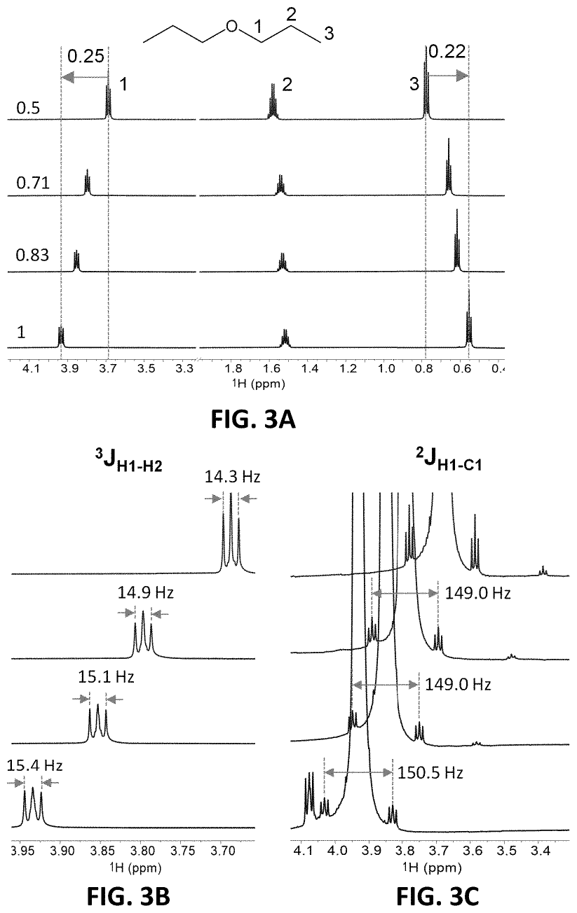

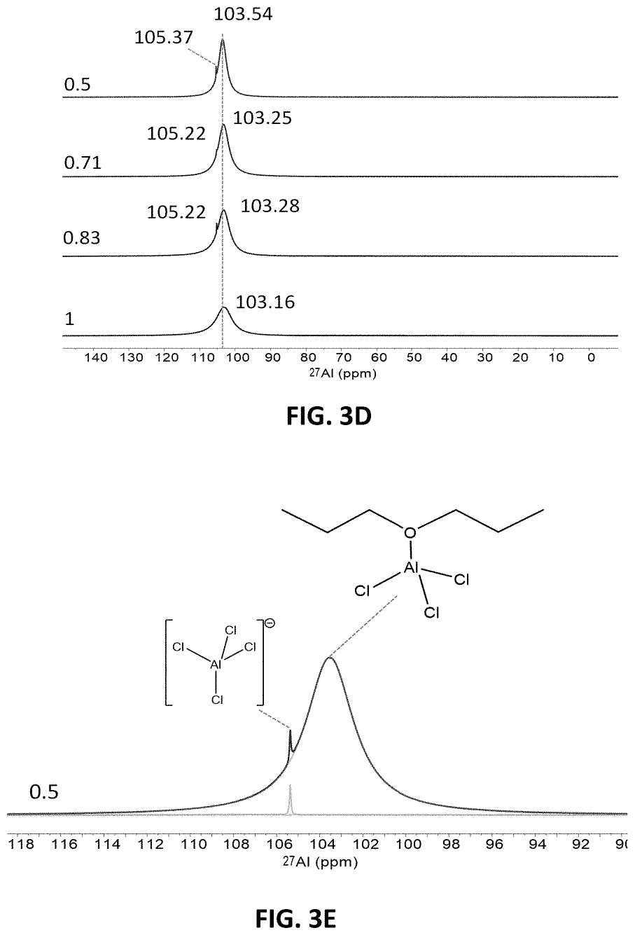

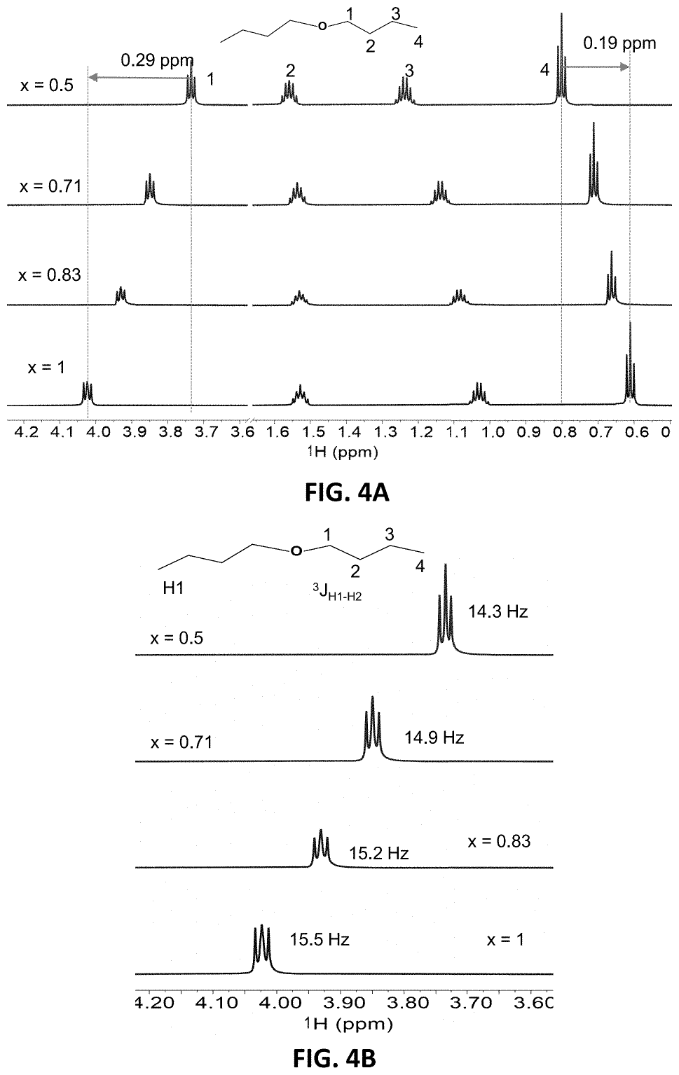

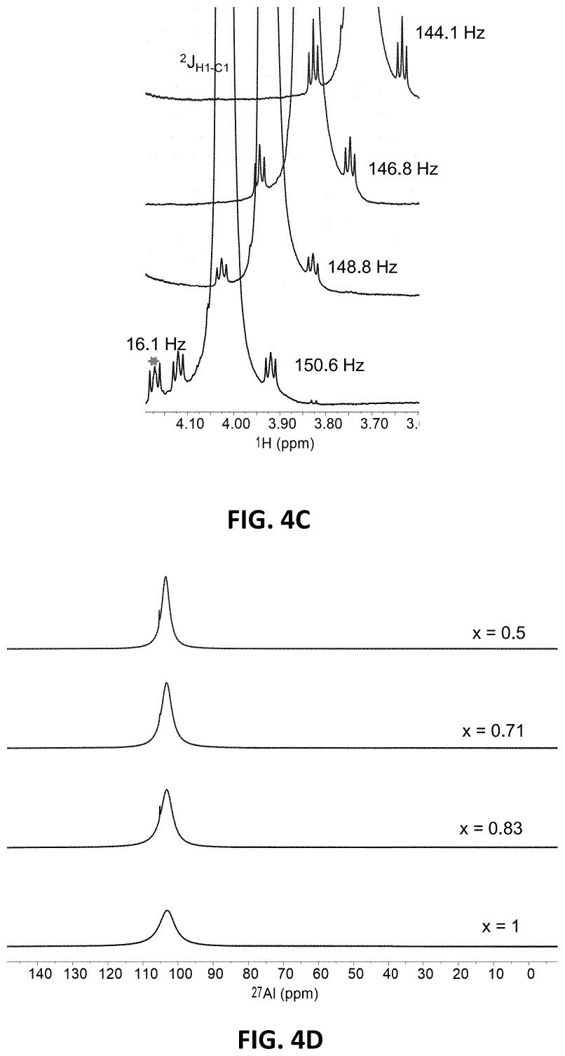

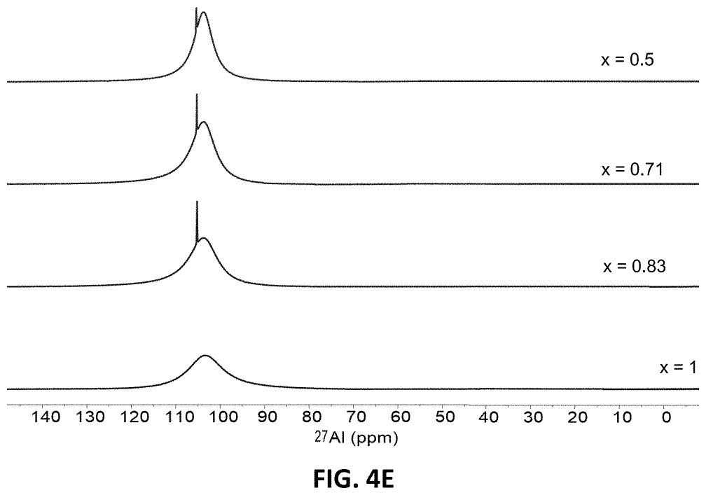

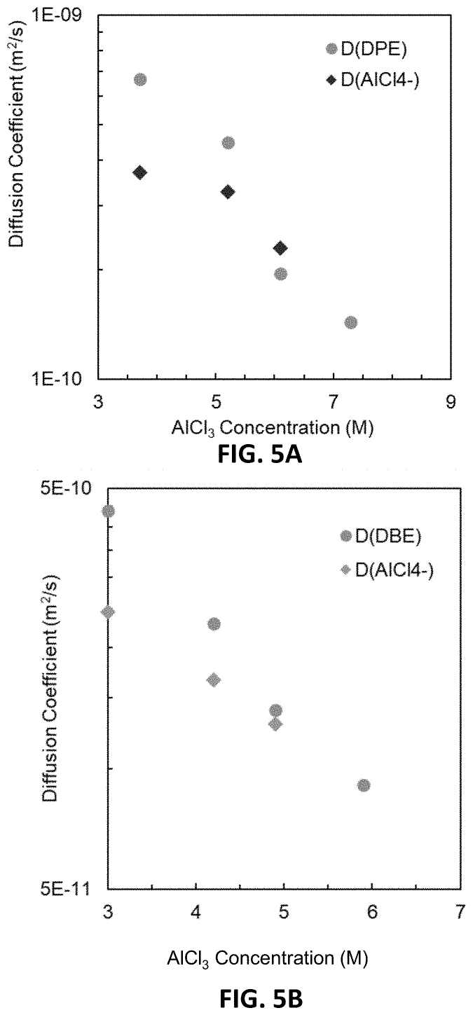

In this example, NMR analyses of an AlCl₃.DPE composition and an AlCl₃.DBE composition were conducted. In particular, the composition comprising a molar ratio of the components between 1 and 0.5 was evaluated to confirm the coordination of the DPE and DBE solvents to AlCl₃ via AI-O bonding. Coordinating DPE has slightly shorter H—C bond length and overall tighter molecular packing (larger²J_{H1-c1} and ³J_{H1-H2}). DPE and DBE coordinated to Al more frequently at higher AlCl₃ concentration (larger²J_{H1-c1} and ³J_{H1-H2} at higher AlCl₃ concentration) (FIGS. 3A-3C for DPE and FIGS. 4A-4C for DBE). ²⁷AI NMR shows mains a signal at 103 ppm, which is attributed to tetra coordinated Al with three chloride atoms and the oxygen atom from the DPE solvent (FIG. 3D). AlCl₃-DPE is non-symmetric and the exchange between bound and free OPE further broadens the ²⁷AI peak. A sharp signal at high frequency of 105 ppm is attributed to symmetric tetracoordinated [AlCl₄]⁻ (FIG. 3E). Results of similar analyses of the DBE-containing complex are provided by FIGS. 4D and 4E.

Table 2 shows the fractions of aluminum containing species in AlCl₃-DPE and AlCl₃-DBE determined using NMR. Aluminum presented in two species, including AlCl₄₋ and neutral species AlCl₃.DPE or AlCl₃.DBE. In both solvents (DPE and DBE), only neutral species AlCl₃.Solvent is existed (100%). At lower AlCl₃:solvent less than 1, two species coexisted. The dominant Al species was the AlCl₃-DPE or AlCl₃-DBE neutral species with the faction of above 99.4% in all range of concentrations evaluated in this example (Table 2). Similar trends were observed in the AlCl₃.DBE solution.

TABLE 2
²⁷Al NMR analysis of electrolyte solution

| AlCl₃:Solvent | | | | |
|---|---|---|---|---|
| molar ratio | | | | |
| (AlCl₃ molar | | δ(²⁷Al) | Width | |
| concentration) | Species | (ppm) | (Hz) | Fraction |
| 1 | AlCl₄_{^{−}} | — | — | 0 |
| (7.3M) | AlCl₃—DPE | 103.16 | 1043.1 | 100 |
| 0.83 | AlCl₄_{^{−}} | 105.19 | 10.9 | 0.29 |
| (6.1M) | AlCl₃—DPE | 103.28 | 787.9 | 99.71 |
| 0.71 | AlCl₄_{^{−}} | 105.22 | 31.0 | 0.33 |
| (5.2M) | AlCl₃—DPE | 103.25 | 690.0 | 99.67 |
| 0.5 | AlCl₄_{^{−}} | 105.37 | 14.9 | 0.56 |
| (3.7M) | AlCl₃—DPE | 103.54 | 523.4 | 99.44 |
| 1 | AlCl₄_{^{−}} | — | — | — |
| (5.8M) | AlCl₃—DPE | 103.65 | 1863.6 | 100 |
| 0.83 | AlCl₄_{^{−}} | 105.20 | 13.7 | 0.81 |
| (4.8M) | AlCl₃—DPE | 103.53 | 1490.7 | 99.19 |
| 0.71 | AlCl₄_{^{−}} | 105.26 | 13.4 | 0.63 |
| (4.1M) | AlCl₃—DPE | 103.60 | 1255.4 | 99.37 |
| 0.5 | AlCl₄_{^{−}} | 105.36 | 17.0 | 0.62 |
| (2.9M) | AlCl₃—DPE | 103.56 | 978.1 | 99.38 |

### Example 4

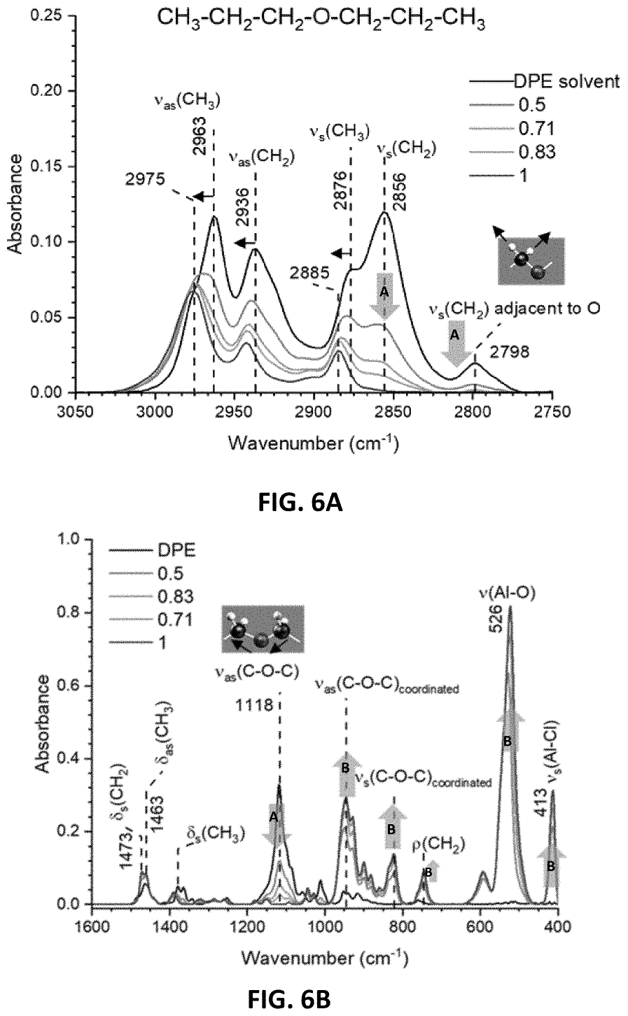

In this example, the interaction of AlCl₃ with DPE solvent was further investigated using infrared spectroscopy (IR). With the addition of AlCl₃ into DPE solvent, C—H vibrations of DPE shows a blue-shift (marked with black arrows in FIG. 6A), indicating the formation of new complex, AlCl₃-DPE. Significantly reduced intensity of vₛ(CH₂) with increased concentration of AlCl₃ (marked with arrows labeled “A”) and signals at 2856 and 2798 cm⁻¹ disappear at 1:1 ratio (no free DPE). This is well consistent with ¹H NMR. It shows that coordinating DPE has slightly shorter H—C bond length and overall tighter molecular packing (larger ²J_{H1-c1} and ³J_{H1-H2}).

With the present of AlCl₃, significant changes in vas(C—O—C) vibration of DPE solvent were observed. With increased AlCl₃ concentration, vas(C—O—C) vibration of free DPE reduced significantly and disappears at 1:1 ratio as indicated by the arrow labeled “A” in FIG. 6B (no free DPE). New signals emerged at 945 and 821 cm⁻¹ is attributed to vas(C—O—C) and vs(C—O—C) of coordinated DPE. New signals appear at 526 cm⁻¹ and 413 cm⁻¹ are assigned to v(AI-O) and vs(Al—Cl). New signals are indicated with arrows B in FIG. 6B. This result is well consistent with those observed in NMR analysis of AlCl₃.DPE solutions.

### Example 5

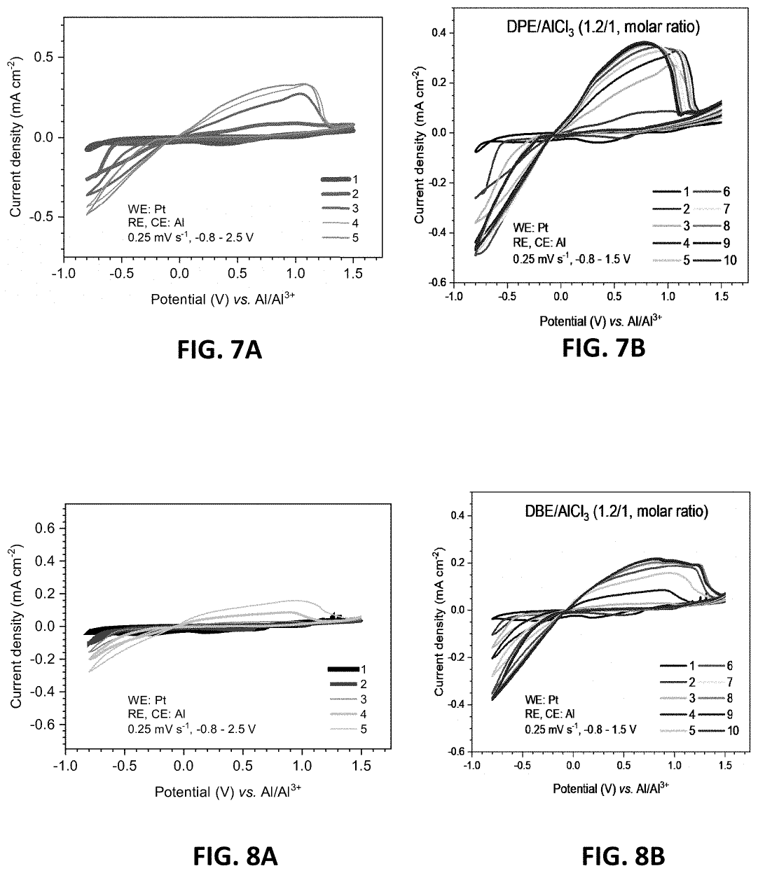

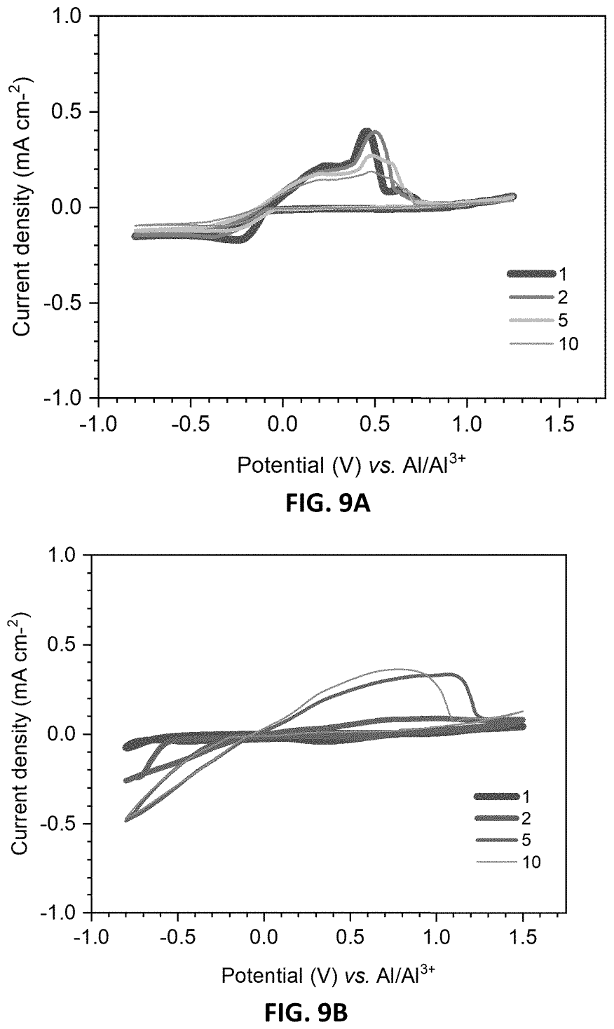

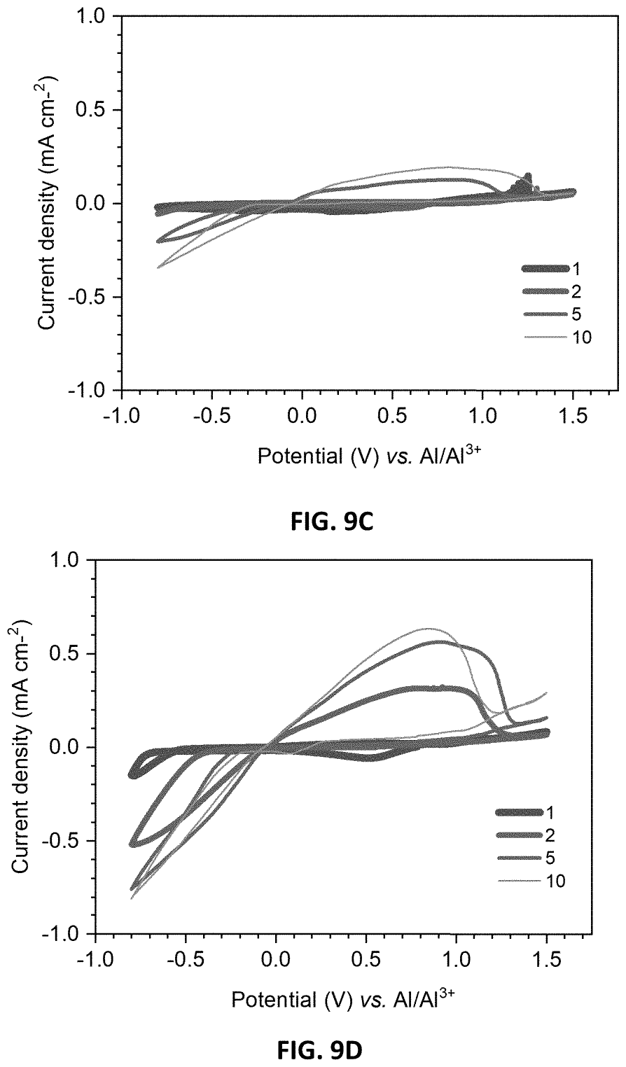

In this example, electrochemical characterization of AlCl₃.DPE and ACl₃.DBE was conducted using cyclic voltammetry between−0.8 and 2.5 V at scan rate of 0.25 mV s⁻¹ at room temperature (results shown in FIGS. 7A and 8A, respectively). Electrochemical characterization of AlCl₃.DPE and ACl₃.DBE also was conducted using cyclic voltammetry between−0.8 and 1.5 V at scan rate of 0.25 mV s⁻¹ at room temperature for up to 10 cycles (results shown in FIGS. 7B and 8B, respectively). Additional testing was conducted for the AlCl₃.DPE with between −0.8 and 1.5 V, with results shown in FIGS. 9A-9D. The reversible AlCl₃ plating stripping was obtained in all molar ratios tested between 1 and 0.5. The low current peaks observed in early cycle and gradually increases with cycle number. Without being limited to a single theory, it currently is believed that this likely is due to the activation of Al foil surface (e.g., elimination of oxide surface, nucleation). The higher current peaks were obtained at low concentration of AlC₃ with molar ratio of 0.5. Without being limited to a single theory, it currently is believed that this likely is due to the higher ionic conductivity of low concentration of AlCl₃. After 10th cycle, the deposition process shows a low overpotential of 0.2 V. The reversible of Al plating and tripping observed in cyclic voltammetry further confirms the potential of these electrolyte solution as electrolyte for electroplating as well as rechargeable battery.

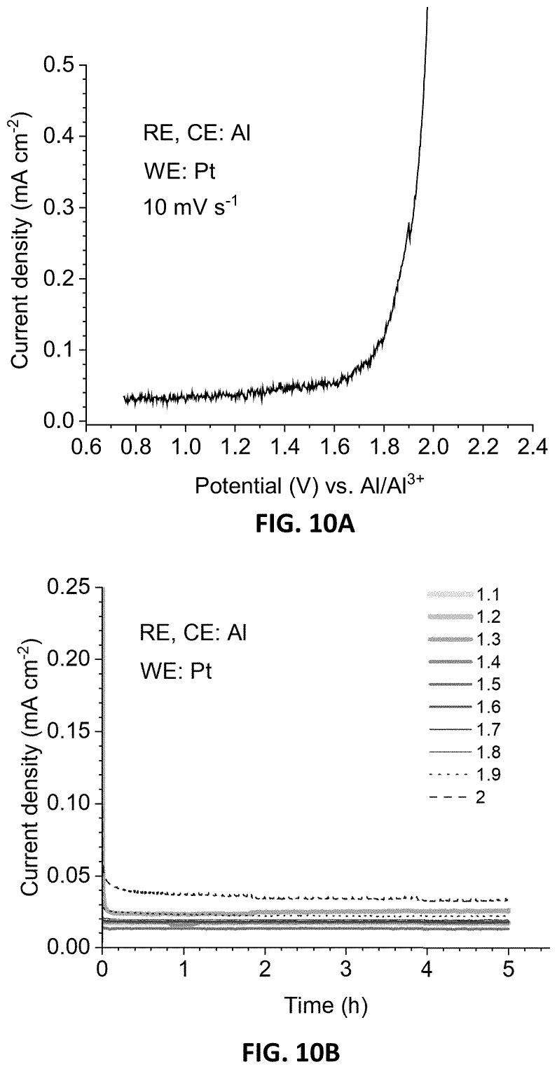

The anodic stability of electrolyte was also characterized using both linear sweep voltammetry (LSV) (results shown in FIG. 10A) and chronoamperometry (results shown in FIG. 10B) on Pt electrode. The LSV shows rapid current flow at 1.6 V. However, the chronoamperometry of electrolyte solution shows small current leak (less than 50 ρA) up to 2.0 V vs. Al/Al³⁺, suggesting the anodic stability of this electrolyte solution on inert electrode at 2.0 V.

### Example 6

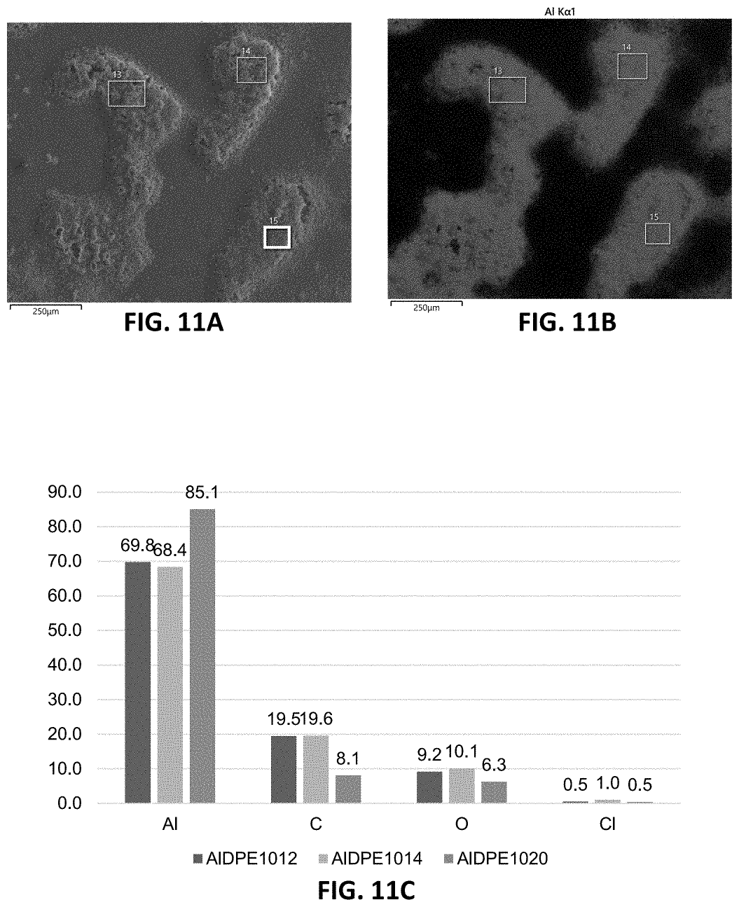

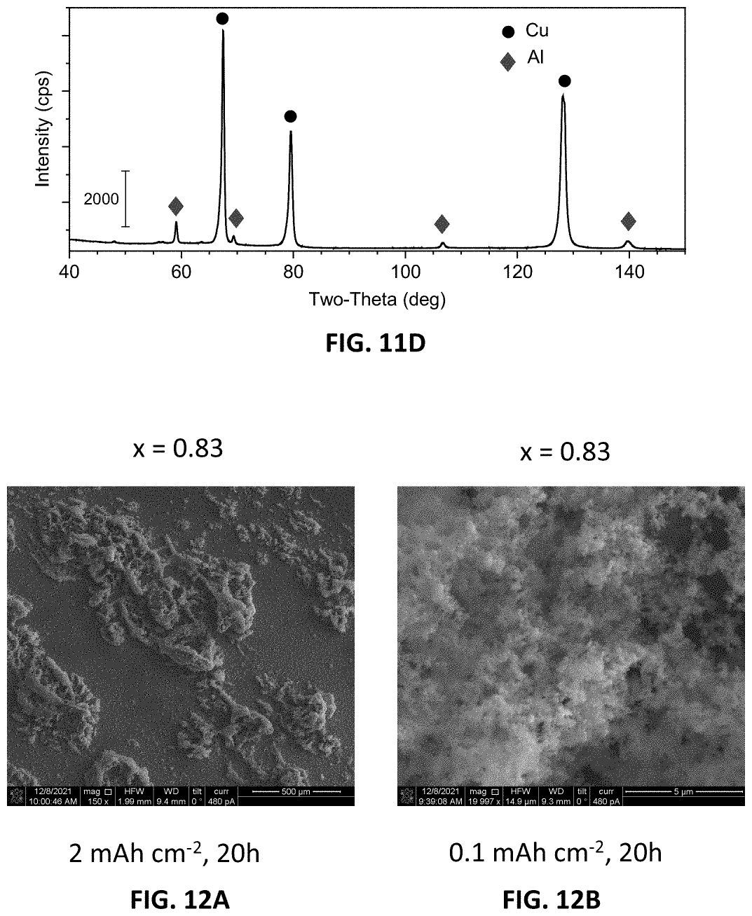

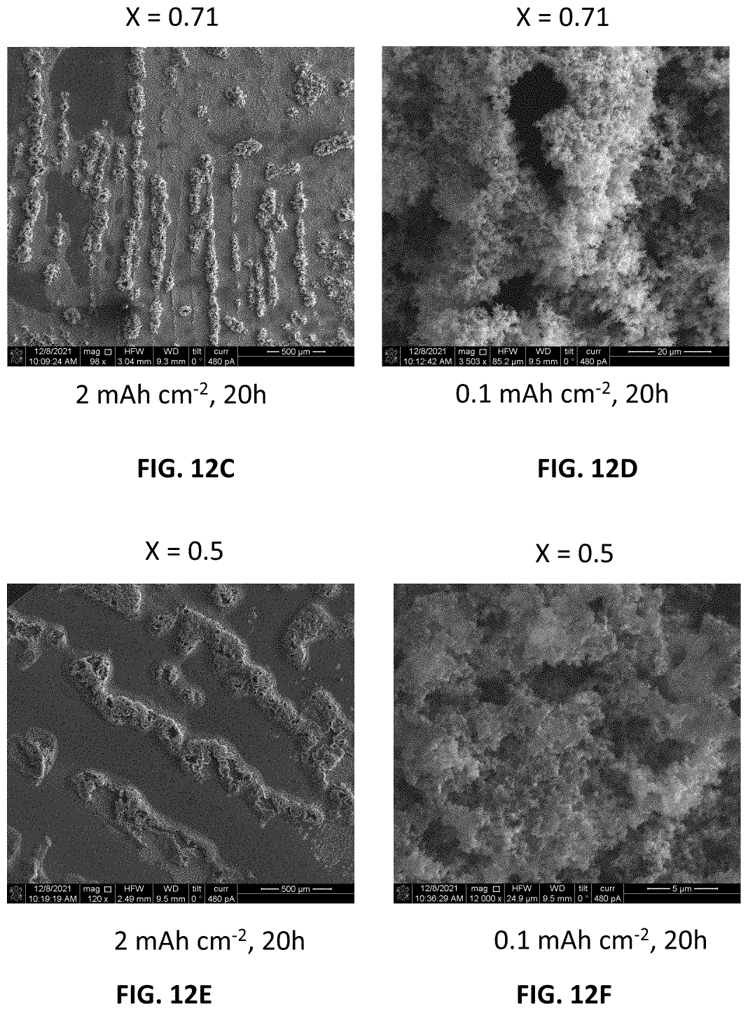

In this example, the morphology, composition, and structure of Al coatings formed via electrodeposition was evaluated, using a representative composition comprising AlCl₃ and DPE. The deposition of Al was conducted using galvanostatic discharge for 20 hours at current density of 0.1 mAh cm⁻². A grey to silver deposition film was obtained in all aluminum-ether-based compositions between 0.83 to 0.5. At the molar ratio of 0.5, a good deposition of Al was obtained while a porous film was obtained at higher concentrations of AlCl₃. FIG. 11A is an SEM image of the film, with FIG. 11B showing elemental mapping. Elemental analysis of Al foil showed a high of Al concentration of 85.1 wt % (FIG. 11C). The XRD analysis of Al deposition film on Cu foil further confirms the deposition of Al polycrystalline from AlCl₃.DPE solution (FIG. 11D). Additional SEM images of the deposited coating are shown in FIGS. 12A-12F, wherein FIG. 12A (x=0.83), 12C (x=0.71), and 12E (x=0.5) show images for different composition concentrations after galvanostatic discharge for 20 hours at current density of 2 mAh cm⁻², and FIG. 12B (x=0.83), 12D (x=0.71), and 12F (x=0.5) show images for different composition concentrations after galvanostatic discharge for 20 hours at current density of 0.1 mAh cm⁻².

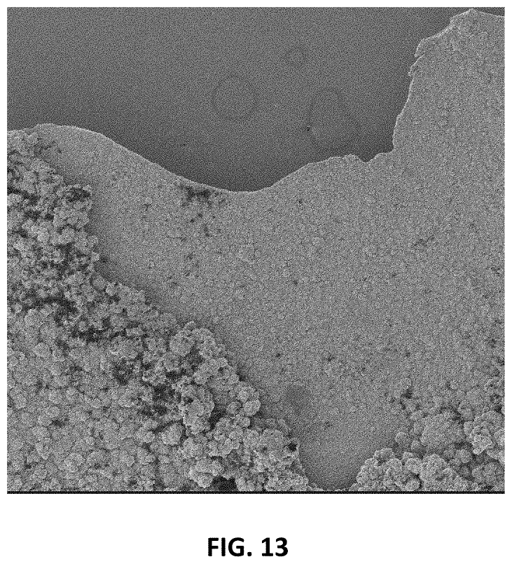

FIG. 13 provides a high-resolution image of an Al deposition film from AlCl₃.DPE (0.5 molar ratio). The image shows thin and dense Al deposition on Cu substrate.

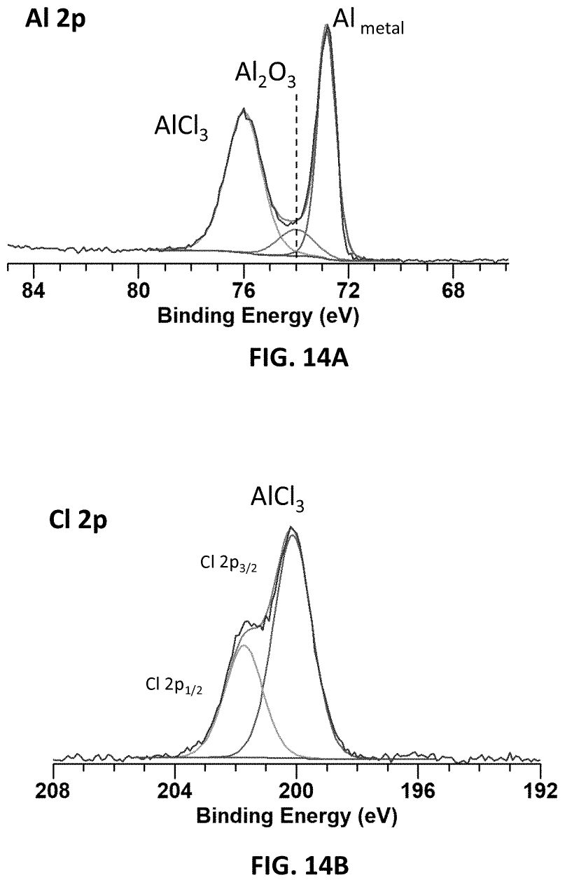

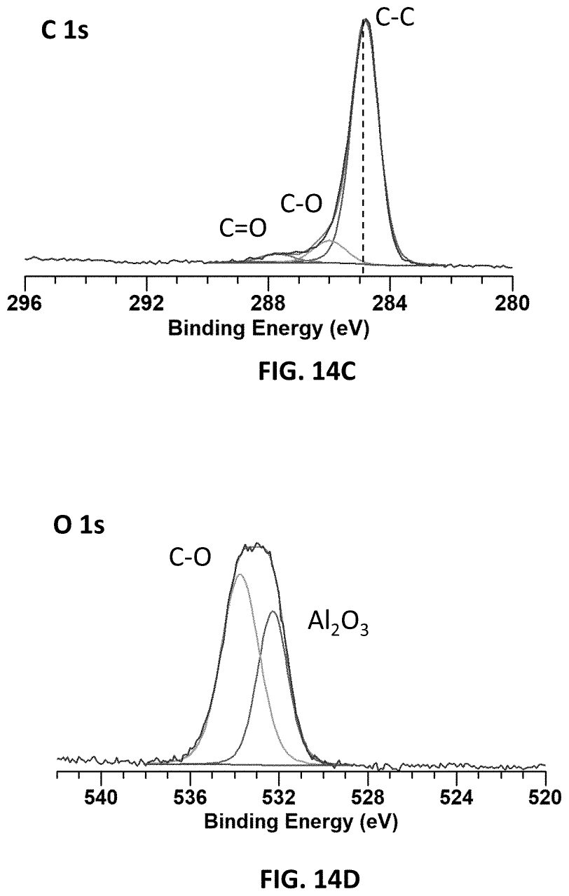

Surface analysis of Al deposition film AlCl₃.DPE was conducted using X-ray photoelectron spectroscopy (see FIGS. 14A-14D). Al 2p spectrum show strong signal at 72.7 eV from Al metal (FIG. 14A). A weak signal at 74 eV indicates the present of a small amount of Al₂O₃. The presence of residual and/or absorbed AlCl₃ on Al surface is also observed in Al 2p spectra and supported by strong signal in Cl 2p spectrum (FIG. 14B). The C 1s spectrum (FIG. 14C) and O 1s spectrum (FIG. 14D) show strong signal of C—O bonding at 286 eV in and 534 eV in O 1s spectra. This signal is attributed to the stable absorption of DPE on the surface of Al film. These results suggest that the AlCl₃.DPE is highly stable against reduction on the surface of Al, making it a promising and efficient electrolyte for Al electroplating and rechargeable battery.

### Example 7

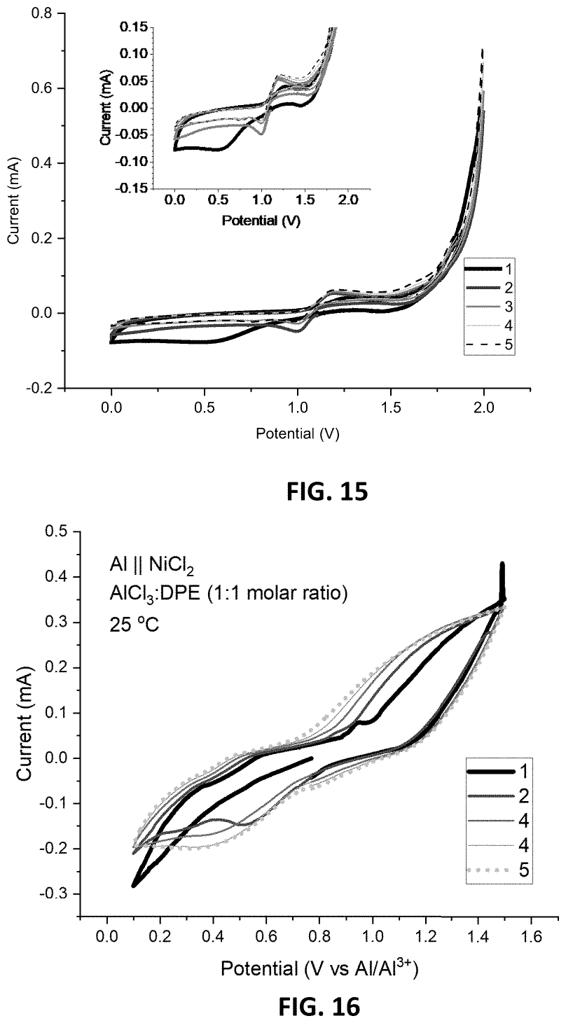

In this example, a rechargeable Al battery was fabricated using V₂O₅ loaded on activated carbon cloth (ACC) as the cathode, Al foil as the anode, and glass fiber as the separator. AlCl₃.DPE (molar ratio of 0.5) was used as the electrolyte. FIG. 15 presents the cyclic voltammetry of V₂O₅-ACC//Al cathode at 25 mV s⁻¹. The cyclic voltammogram of the cell shows a cathodic peak at 1.0 V vs. Al/Al³⁺ (inset of FIG. 15), corresponding to the intercalation of Al³⁺ into V₂O₅ cathode (V₂O₅+xAl³⁺+3xe⁻→AlxV₂O₅). In the reverse scan, the CV shows an anodic peak at 1.2 V vs. Al/Al³⁺, corresponding the oxidation of AlxV₂O₅. Without being limited to a single theory, it currently is believed that the high current density above 1.8 V could be due to oxidation of the electrolyte on the surface of carbon and/or V₂O₅ cathode. Additional results are shown in FIG. 16 for a battery comprising a cathode with a NiCl₂ and sulfur material, an aluminum anode and a AlCl₃.DPE composition at a 1:1 molar ratio. The cyclic voltammetry was scanned between 0.1-1.5 V vs. Al/Al³⁺ at a scan rate of 10 mV/s. The tested was conducted at room temperature

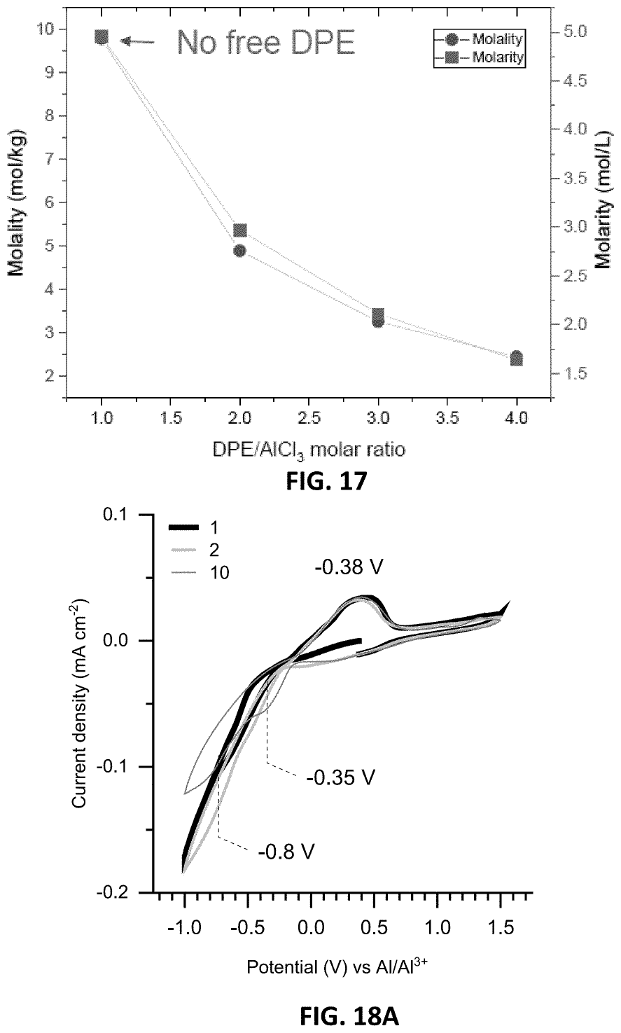

FIG. 17 presents the molar concentration and molality concentration of AlCl₃. DPE with molar ratios between DPE to AlCl₃ at 1:1, 1:2, 1:3, and 1:4. These results demonstrates excellent solubility of Al³⁺ in DPE solvents, which are significantly higher than conventional electrolyte for other type of batteries such as Li-ion batteries.

### Example 8

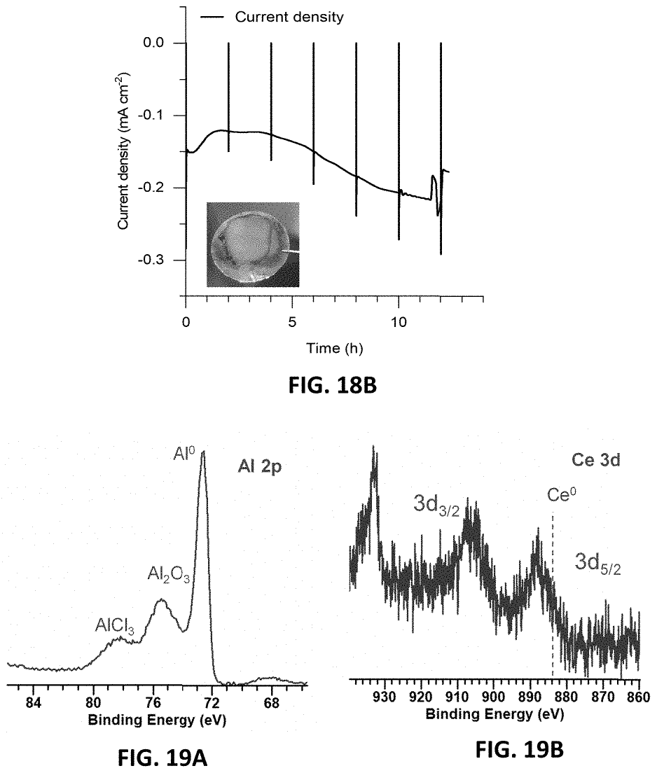

In this example, an Al—Ce alloy coating was deposited using a composition according to the present disclosure. To deposit the Al—Ce alloy, a small amount (0.25 M) of CeCl₃ (Ce³⁺+3e⁻⇄Ce, −2.336 V) was added to AlCl₃:DPE (0.5) and stirred for 12 hours. The CeCl₃ reached its saturation level and small amount of CeCl₃ crystal remained in the vial. The clear solution was separated and used for electrochemical testing. FIG. 18A shows the cyclic voltammograms of Al—Ce deposition, with low overpotential of Al plating (−0.1 V) and reversible Al plating/stripping features, similar to that in AlCl₃.DPE electrolyte system. Interestingly, the plating process showed two cathodic peaks at −0.35 V and −0.85 V vs Al/Al³⁺. Without being limited to a single theory, it currently is believed that the first cathodic peak at −0.35V was related to the Al³⁺+3e⁻→Al⁰ reaction, while signals at −0.85V were related to Ce³⁺ reduction. To verify the deposition composition, the pulsed constant voltage deposition of Al—Ce alloy (FIG. 18B) at −1.5 V vs. AI/Al³⁺ was used. The silver-grey metallic deposition film with strong adhesion was obtained on Cu foil (FIG. 18A, insert).

XPS analysis of the deposited metal film revealed the presentation of metallic Al, along with small amount of Al₂O₃ and AlCl₃ (FIG. 19A). In the Ce 3d spectrum (FIG. 19B), a broad signal in the region of 880-895 eV (Ce 3d_{5/2}) and 900-915 eV (Ce 3d_{3/2}) confirmed the deposition of Ce. The broad signal suggested the presence of a mixture of Ce compounds such as Ce⁰ and its oxides. These results show that the alloy of Al—Ce can be formed under electrochemical deposition.

In view of the many possible aspects of the disclosure to which the principles of the present disclosure may be applied, it should be recognized that the illustrated aspects of the disclosure are only preferred examples and should not be taken as limiting the scope of the disclosure. Rather, the scope is defined by the following claims. We therefore claim as our invention all that comes within the scope and spirit of these claims.

We claim:

1. An aluminum-ether-based composition for use in electroplating an aluminum metal coating or for use in an aluminum battery, comprising:
an aluminum salt component having a structure according to a formula AlX₃, wherein each X independently is a halogen atom; and
an ether-based solvent having a structure according to a formula R¹—O—R², wherein each of R¹ and R² independently is selected from C₃₋₂₀alkyl, C₃₋₂₀alkenyl, C₃₋₂₀alkynyl, C₃₋₂₀haloalkyl, C₃₋₂₀haloalkenyl, or C₃₋₂₀haloalkynyl;
wherein the aluminum salt component and the ether-based solvent are present in amounts that provide a molar ratio of 0.01 to 1.5 (aluminum salt component:ether-based solvent) and the aluminum-ether-based composition does not comprise, or is free of, a metal hydride and/or an ionic liquid.

2. The aluminum-ether-based composition of claim 1, wherein the aluminum salt component is AlCl₃, AlF₃, AlBr₃, AI(I)₃, or a combination thereof.

3. The aluminum-ether-based composition of claim 1, wherein the aluminum salt component is AlCl₃.

4. The aluminum-ether-based composition of claim 1, wherein each of R¹ and R² independently is selected from C₃₋₁₀alkyl or C₃₋₁₀haloalkyl.

5. The aluminum-ether-based composition of claim 1, wherein each of R¹ and R² independently is selected from n-propyl, n-butyl, n-pentyl, or any fluorinated version thereof.

6. The aluminum-ether-based composition of claim 1, comprising AlCl₃ and a mixture of two or more ether-based solvents.

7. The aluminum-ether-based composition of claim 1, wherein the molar ratio ranges from 0.5 to 1.

8. The aluminum-ether-based composition of claim 1, further comprising a rare earth element component having a formula REE(Z)ₙ, wherein:
REE is selected from lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), scandium (Sc), yttrium (Y), or combinations thereof;
each Z independently is selected from a halogen; a polyatomic anion; an alkoxy group having a formula R³O—, wherein R³ is selected from an aliphatic group, an aromatic group, a haloaliphatic group, or a combination thereof; or a combination thereof; and
n is an integer selected from 3 or 4.

9. The aluminum-ether-based composition of claim 8, wherein the rare earth element component is CeCl₃.

10. A battery, comprising:
the aluminum-ether-based composition of claim 1;
an aluminum anode; and
a cathode.

11. The battery of claim 10, wherein the cathode is a metal-halid-based cathode, a vanadium-based cathode, an organic cathode, or a metal-chalcogenide-based cathode.

12. The battery of claim 10, wherein the aluminum-ether-based composition comprises (i) AlC₃ and (ii) dipropyl ether or dibutyl ether, wherein (i) and (ii) are present in amounts providing a ratio ranging from 0.5 to 1.

13. A method, comprising applying a voltage to a system comprising an aluminum-containing substrate, a second substrate, and the aluminum-ether-based composition of claim 1, wherein the aluminum-containing substrate and the second substrate are positioned at a distance from one another, and the aluminum-ether-based composition comes into fluid contact with both the aluminum-containing substrate and the second substrate.

14. The method of claim 13, wherein the aluminum-containing substrate is an aluminum anode and the second substrate is a cathode.

15. The method of claim 13, wherein the voltage is a charging voltage and is applied as DC, AC, or a combination thereof.

16. The method of claim 13, wherein applying the voltage to the system results in Al³⁺ ion transport between the aluminum anode and the cathode and through the aluminum-ether-based composition.

17. The method of claim 13, wherein the method produces electrical energy.

18. The method of claim 13, wherein the system further comprises a separator and/or a membrane component positioned between the aluminum-containing substrate and the second substrate.

19. The method of claim 13, wherein the aluminum-containing substrate is an aluminum metal counter electrode and the second substrate is a working electrode and comprises a substrate upon which aluminum metal can be deposited upon exposure of the system to the voltage.

20. The method of claim 19, wherein the voltage is a negative potential versus Al/Al³⁺, or a negative current applied to the substrate upon which the aluminum metal is deposited.

21. The method of claim 19, wherein applying the voltage to the system results in electrodepositing an aluminum metal layer on the second substrate; or wherein the aluminum-ether-based composition further comprises a rare earth element component and applying the voltage to the system results in electrodepositing an aluminum-rare earth element alloy layer on the second substrate.
